(19) United States
(12) Patent Application Publication
(10) Pub. No.: US 2026/0172719 A1
(43) Pub. Date: Jun. 18, 2026

(54) PHOTODETECTION ELEMENT AND ELECTRONIC EQUIPMENT

(71) Applicant: SONY SEMICONDUCTOR SOLUTIONS CORPORATION, KANAGAWA (JP)

(72) Inventor: KAZUTOSHI KODAMA, KANAGAWA (JP)

(21) Appl. No.: 19/127,419

(22) PCT Filed: Oct. 26, 2023
(86) PCT No.: PCT/JP2023/038768

§ 371 Date: May 6, 2025

(30) Foreign Application Priority Data
Nov. 14, 2022 (JP) 2022-182010

(51) Int. Cl. H04N 25/78

(52) U.S. Cl. CPC H04N 25/78

(57) ABSTRACT

Provided are a photodetection element and electronic equipment capable of suppressing an influence of voltage fluctuation of a signal line. According to the present disclosure, there is provided a photodetection element including: a pixel array section that disposes a first pixel and a second pixel different from the first pixel along the same light receiving surface; a conversion section that performs analog-digital conversion of an output signal output from the first pixel via a signal line into a digital signal; a signal holding section that is capable of holding an output signal of the second pixel and suppresses fluctuation of the output signal according to a period of the analog-digital conversion; and a first circuit that outputs a detection signal indicating occurrence of an event in a case where the output signal exceeds a predetermined threshold.

### TECHNICAL FIELD

The present disclosure relates to a photodetection element and electronic equipment.

### BACKGROUND ART

A synchronous gradation pixel that captures image data (frames) in synchronization with a synchronization signal such as a vertical synchronization signal is used in a photodetection element or the like. Furthermore, an asynchronous event-based vision sensor (EVS) has been proposed to output event data representing occurrence of an event in a case where the event occurs with a luminance change in a pixel as the event. Furthermore, a method of utilizing a result of detecting the occurrence of an event by the asynchronous EVS for imaging has been studied.

### CITATION LIST

### Patent Document

Patent Document 1: Japanese Patent Application Laid-Open No. 2021-129265

### SUMMARY OF THE INVENTION

### Problems to be Solved by the Invention

As a part of such a utilization method, a synchronous gradation pixel and an EVS pixel constituting an event-based vision sensor are being configured on the same imaging surface. However, the voltage of a signal line of the gradation pixel fluctuates due to the reading of the EVS pixel, which may affect AD conversion characteristics.

Therefore, the present disclosure provides a photodetection element and electronic equipment capable of suppressing the influence of the voltage fluctuation of the signal line.

### Solutions to Problems

In order to solve the above-described problem, according to the present disclosure, there is provided a photodetection element including:
a pixel array section that disposes a first pixel and a second pixel different from the first pixel along the same light receiving surface;
a conversion section that performs analog-digital conversion of an output signal output from the first pixel via a signal line into a digital signal;
a signal holding section that is capable of holding an output signal of the second pixel and suppresses fluctuation of the output signal according to a period of the analog-digital conversion; and
a first circuit that outputs a detection signal indicating occurrence of an event in a case where the output signal of the second pixel exceeds a predetermined threshold.

The second pixel may include:
a photoelectric conversion element that outputs a signal according to an amount of received light; and
a voltage conversion section that converts the signal into a voltage signal, and
the signal holding section may hold the voltage signal of the voltage conversion section and suppresses fluctuation of the voltage signal.

The pixel array section may include:
a plurality of the first pixels arranged two-dimensionally along the light receiving surface; and
a plurality of the second pixels arranged two-dimensionally along the light receiving surface,
the photodetection element may further include a plurality of the signal holding sections respectively corresponding to the plurality of second pixels,
during a period in which the analog-digital conversion of the output signal via the signal line is performed, the signal holding sections of the second pixels in a predetermined range from the signal line may suppress fluctuation of the corresponding output signal.

A control section that controls a supply potential of the voltage conversion section may be further included, and the control section may be capable of suppressing driving of the voltage conversion section of each of the second pixels in a predetermined range from the signal line in a period in which the analog-digital conversion of the output signal via the signal line is performed.

The signal holding section may include:
a capacitance that holds an output signal of the second pixel; and
a first switching element that brings a signal line connecting the capacitance and the second pixel into a conductive state or a non-conductive state.

The signal holding section may further include
a buffer capable of outputting a potential according to a charge of the capacitance to the first circuit.

The signal holding section may further include
a second switching element that brings a signal line connecting the second pixel and the first circuit into a conductive state or a non-conductive state.

The first switching element may include one end connected to a signal line connecting the second pixel and the first circuit and the other end connected to an input terminal of the buffer, and
may further includes
a second switching element including one end connected to an output terminal of the buffer and the other end connected to the second pixel.

The first switching element may include one end connected to the second pixel and the other end connected to the first circuit,
an input terminal of the buffer may be connected to the first circuit, and
the photodetection element may further include a second switching element including one end connected to an output terminal of the buffer and the other end connected to the second pixel.

The signal holding section may further include:
an operational amplifier, a 12th switching element, a 21st switching element, and a 22nd switching element,
the first switching element may include one end connected to a signal line connecting the second pixel and the first circuit and the other end connected to one end of the capacitance,
the other end of the capacitance may be connected to an inverting input terminal of the operational amplifier,
a non-inverting input terminal of the operational amplifier may be connected to a predetermined low potential,
the 21st switching element may include one end connected to an output terminal of the operational amplifier and the other end connected to the second pixel,
the 12th switching element may include one end connected to the output terminal of the operational amplifier and the other end connected to the other end of the capacitance, and
the 22nd switching element may include one end connected to the output terminal of the operational amplifier and the other end connected to the one end of the capacitance.

The signal holding section may further include:
an operational amplifier, a 12th switching element, a 21st switching element, and a 22nd switching element,
the first switching element may include one end connected to the second pixel and the other end connected to the first circuit,
one end of the capacitance may be connected to the first circuit and the other end of the capacitance may be connected to an inverting input terminal of the operational amplifier,
a non-inverting input terminal of the operational amplifier may be connected to a predetermined low potential,
the 21st switching element may include one end connected to an output terminal of the operational amplifier and the other end connected to the second pixel,
the 12th switching element may include one end connected to the output terminal of the operational amplifier and the other end connected to the other end of the capacitance, and
the 22nd switching element may include one end connected to the output terminal of the operational amplifier and the other end connected to the one end of the capacitance.

The first switching element may be brought into a non-conductive state and the second switching element may be brought into a conductive state according to a period of the analog-digital conversion.

The first switching element may be brought into a conductive state and the second switching element may be brought into a non-conductive state during a sampling period in which charges are accumulated in the capacitance.

The first switching element may be brought into a non-conductive state and the second switching element may be brought into a conductive state according to a period of the analog-digital conversion.

The first switching element may be brought into a non-conductive state and the second switching element may be brought into a conductive state according to a period of the analog-digital conversion.

The first switching element and the 12th switching element may be brought into a non-conductive state, and the 21st switching element and the 22nd switching element may be brought into a conductive state according to a period of the analog-digital conversion.

The first switching element and the 12th switching element may be brought into a conductive state, and the 21st switching element and the 22nd switching element may be brought into a non-conductive state during a sampling period in which charges are accumulated in the capacitance.

The first switching element and the 12th switching element may be brought into a non-conductive state, and the 21st switching element and the 22nd switching element may be brought into a conductive state according to a period of the analog-digital conversion.

The pixel array section may be configured in a first element, and
the conversion section, the signal holding section, and the first circuit may be configured in a second element different from the first element.

According to the present disclosure, there is provided electronic equipment including:
the photodetection element; and
an optical system that focuses light on the light receiving surface.

### BRIEF DESCRIPTION OF DRAWINGS

FIG. 1 is a block diagram illustrating a configuration example of an imaging device according to an embodiment of the present technology.

FIG. 2 is a diagram illustrating an example of a stacked structure of a photodetection element in the embodiment of the present technology.

FIG. 3 is a diagram schematically illustrating EVS pixels and gradation pixels arranged in a matrix.

FIG. 4 is a block diagram illustrating a configuration example of an AD converter.

FIG. 5 is a circuit diagram illustrating an example of a configuration of the EVS pixel.

FIG. 6 is a diagram illustrating a circuit example of a gradation pixel.

FIG. 7 is a diagram illustrating a parasitic capacitance between the EVS pixel and a vertical signal line of the gradation pixel.

FIG. 8 is a diagram illustrating a configuration example of an event detection section of an AFE array section for EVS.

FIG. 9 is a circuit diagram illustrating an example of a configuration of a subtractor and a quantizer.

FIG. 10 is a circuit diagram illustrating a configuration example of a pixel voltage holding section.

FIG. 11 is a diagram illustrating a sampling operation of the pixel voltage holding section.

FIG. 12 is a diagram illustrating a hold operation of the pixel voltage holding section.

FIG. 13 is a diagram illustrating a control example of the pixel voltage holding section by a row control section.

FIG. 14 is a diagram schematically illustrating a case where the sampling operation is continued and a case where the hold operation is performed.

FIG. 15 is a diagram illustrating a configuration example of a pixel voltage holding section according to Modification 1 of the first embodiment.

FIG. 16 is a diagram illustrating a configuration example of a pixel voltage holding section according to Modification 2 of the first embodiment.

FIG. 17 is a diagram illustrating a configuration example of a pixel voltage holding section according to Modification 3 of the first embodiment.

FIG. 18 is a diagram illustrating a configuration example of a pixel voltage holding section according to Modification 4 of the first embodiment.

FIG. 19 is a diagram illustrating a processing example in which the processing illustrated in FIG. 17 is performed for three cycles.

FIG. 20 illustrates a configuration example of a second embodiment.

FIG. 21 is a diagram illustrating a configuration example of a logic section.

FIG. 22 is a diagram illustrating a structure example of three layers.

FIG. 23 is a block diagram illustrating an example of a schematic configuration of a vehicle control system.

FIG. 24 is a block diagram illustrating a schematic configuration example of a vehicle control system 7000 as an example of a mobile body control system to which the technology according to the present disclosure can be applied.

FIG. 25 is an explanatory diagram illustrating an example of installation positions of an outside-vehicle information detecting section and an imaging section.

### MODE FOR CARRYING OUT THE INVENTION

Hereinafter, embodiments of a photodetection element and electronic equipment will be described with reference to the drawings. Although principal configuration parts of the photodetection element and the electronic equipment will be mainly described below, the photodetection element and the electronic equipment may include configuration parts and functions that are not illustrated or described. The following description is not intended to exclude configuration parts and functions that are not illustrated or described.

### First Embodiment

### [Configuration Example of Imaging Device]

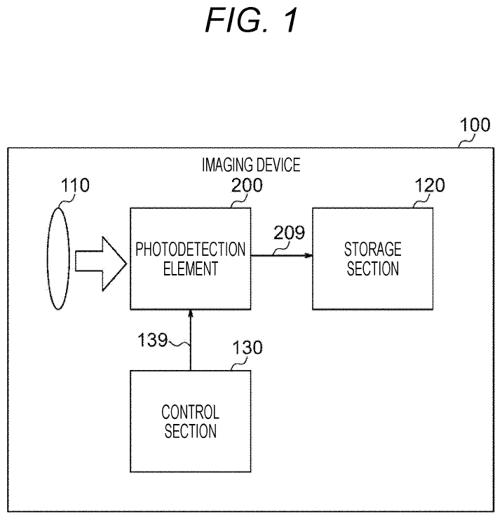

FIG. 1 is a block diagram illustrating a configuration example of an imaging device 100 according to an embodiment of the present technology. The imaging device 100 includes an imaging lens 110, a photodetection element 200, a recording section 120, and a control section 130. As the imaging device 100, a camera mounted on a wearable device, or electronic equipment such as a vehicle-mounted camera is assumed. Note that the imaging lens 110 according to the present embodiment corresponds to an optical system, and the imaging device 100 corresponds to electronic equipment.

The imaging lens 110 condenses incident light and guides the light to the photodetection element 200. The photodetection element 200 includes EVS pixels and gradation pixels. That is, the EVS pixel and the gradation pixel are arranged on the light receiving surface of the photodetection element 200, and an optical image via the imaging lens 110 is detected. That is, the detection target range of the EVS pixel and the imaging target range of the gradation pixel coincide with each other without performing calibration.

Furthermore, the photodetection element 200 can detect that the absolute value of an amount of change in luminance in the EVS pixel exceeds a threshold as an address event. The address event includes, for example, an on-event indicating that an amount of increase in luminance exceeds an upper limit threshold and an off-event indicating that an amount of decrease in luminance falls below a lower limit threshold less than the upper limit threshold. Then, the photodetection element 200 generates a detection signal indicating a detection result of the address event for each pixel for EVS. Each detection signal includes an on-event detection signal indicating presence or absence of an on-event and an off-event detection signal indicating presence or absence of an off-event. Note that, although the photodetection element 200 detects the presence or absence of both the on-event and the off-event, it can detect only one of them.

On the other hand, the gradation pixel outputs a gradation luminance signal. A gradation image is formed on the basis of the gradation luminance signal output from the gradation pixel. The photodetection element 200 performs predetermined signal processing such as image recognition processing on the gradation image, and outputs processed data to the recording section 120 via a signal line 209.

The recording section 120 is configured to record data from the photodetection element 200. The control section 130 is configured to control the photodetection element 200 to capture image data.

### [Configuration Example of Solid-State Imaging Element]

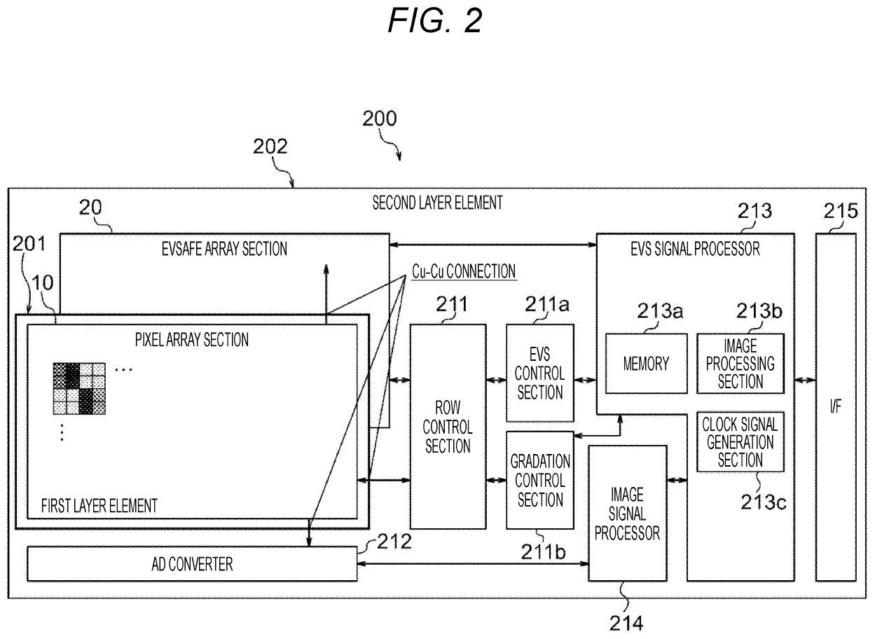

FIG. 2 is a diagram illustrating an example of a stacked structure of the photodetection element 200 in the embodiment of the present technology. The photodetection element 200 includes a first layer element (top part) 201 and a second layer element (bottom part) 202. These substrates are electrically connected by Cu—Cu bonding. Note that the connection can be made using a via or a bump.

As illustrated in FIG. 2, the photodetection element 200 according to the present disclosure is a device capable of independently performing asynchronous imaging using the EVS pixel and synchronous imaging for a gradation image. That is, the pixel array section 10 is configured in the first layer element (top part) 201, and the second layer element 202 (bottom part) includes an analog front end (AFE) array section 20 for EVS pixels, a row control circuit 211, an AD converter 212, an EVS signal processor 213, an image signal processor 214, and an input/output interface 215. The row control circuit 211 includes an EVS control section (arbiter) 211a and a gradation control section 211b. The EVS signal processor 213 includes a memory 213a, an image processing section 213b, and a clock signal generation section 213c.

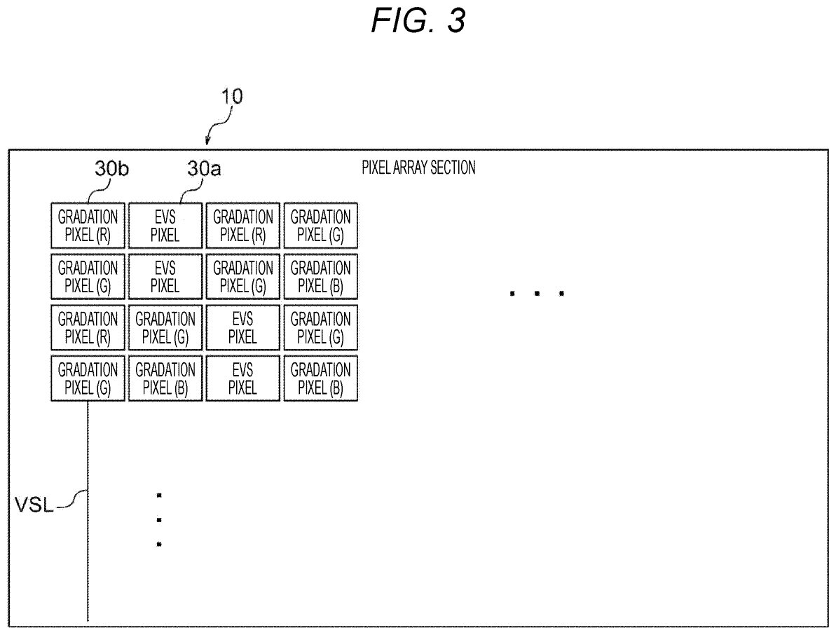

Here, a configuration of the pixel array section 10 will be described with reference to FIG. 3. FIG. 3 is a diagram schematically illustrating EVS pixels 30a and gradation pixels 30b arranged in a matrix in the pixel array section 10. As illustrated in FIG. 3, in the pixel array section 10, a plurality of gradation pixels 30b and a plurality of EVS pixels 30a are two-dimensionally arranged in a matrix (array). Note that R, G, and B are examples of color filters arranged in the gradation pixel 30b. That is, R represents a red filter, G represents a green filter, and B represents a blue filter. As described above, the photodetection element 200 according to the present embodiment is a so-called mixed type.

On the other hand, the EVS pixel 30a outputs an analog signal of a voltage according to a photocurrent to the AFE array section 20 for EVS. Note that details of the EVS pixel 30a will be described later.

On the other hand, each of the gradation pixels 30b generates an analog signal of a voltage according to a photocurrent as a gradation luminance signal and outputs the generated signal to the AD converter 212 (see FIG. 2). A vertical signal line VSL is wired for each pixel column of the gradation pixels 30b. Note that details of the gradation pixel 30b will also be described later.

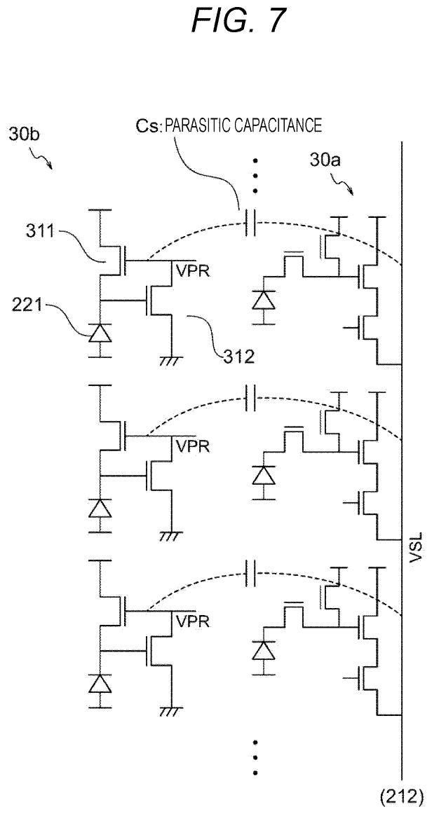

As illustrated in FIG. 2 again, the AFE array section 20 for EVS detects the presence or absence of an event based on whether or not the change amount of the photocurrent in the EVS pixel 30a exceeds a predetermined threshold value. The AFE array section 20 for EVS includes a plurality of event detection sections 20a (see FIG. 7 described later) corresponding to the EVS pixels 30a, respectively. Then, in a case where an event is detected, the AFE array section 20 for EVS outputs a request for requesting the output of event data representing occurrence of the event to the EVS control section (arbiter) 211a. Then, in a case where the AFE array section 20 for EVS receives a response representing permission for the output of the event data from the EVS control section (arbiter) 211a, the AFE array section 20 for EVS outputs the event data to the memory 213a.

The EVS control section 211a arbitrates the request from the event detection section 20a constituting the AFE array section 20 for EVS, and returns a response representing permission or non-permission of the output of the event data to the AFE array section 20 for EVS. Furthermore, after outputting the response representing permission for the output of the event data, the EVS control section 211a outputs a reset signal for resetting event detection to the AFE array section 20 for EVS.

The memory 213a accumulates the event data from the AFE array section 20 for EVS, for example, in sections of a predetermined frame. The frame section in which the memory 213a accumulates the event data from the AFE array section 20 for EVS is controlled by the image processing section 213b. On the basis of the clock signal supplied from the clock signal generation section 213c, the memory 213a adds a count value as time information representing the (relative) time at which the event occurs to the event data and accumulates the count value. That is, the memory 213a stores event data including at least position coordinates (coordinates or the like) representing the position of the EVS pixel 30a or the EVS pixel 30a at which the event has occurred and time information representing the time at which the event has occurred. In addition, in the event data, the polarity (positive or negative) of a light amount change can be included.

The image processing section 213b performs data processing (image processing) in accordance with the event data (frame data) in frame sections accumulated in the memory 213a, and outputs a data processing result that is a result of the data processing. For example, the image processing section 213b extracts contour information of an object from the event data in units of frames, and specifies the object to be detected. The image processing section 213b determines a region of interest (ROI) including the specified object, and outputs the region of interest to the gradation control section 211b. The clock signal generation section 213c generates a clock signal serving as a master clock, and supplies the clock signal to the memory 213a, the image processing section 213b, and the like.

The gradation control section 211b drives the gradation pixel 30b of the pixel array section 10 by supplying a control signal to the pixel array section 10. For example, the gradation control section 211b drives the gradation pixel 30b of a region of interest on the basis of the ROI information that is the information of the region of interest supplied from the image processing section 213b, and supplies (outputs) the pixel signal of the gradation pixel 30b to the AD converter 212. Note that, as a matter of course, the gradation control section 211b can drive not only a partial region of the pixel array section 10 but also the entire region of the pixel array section 10 to supply (output) the pixel signals of the gradation pixels 30b in the entire region to the AD converter 212.

The row control section 211 can perform integrated control processing of the EVS control section (arbiter) 211a and the gradation control section 211b. For example, the row control section 211 controls the reading timing in the EVS pixel 30a that affects the AD converter 212 of the luminance signal in the gradation pixel 30b.

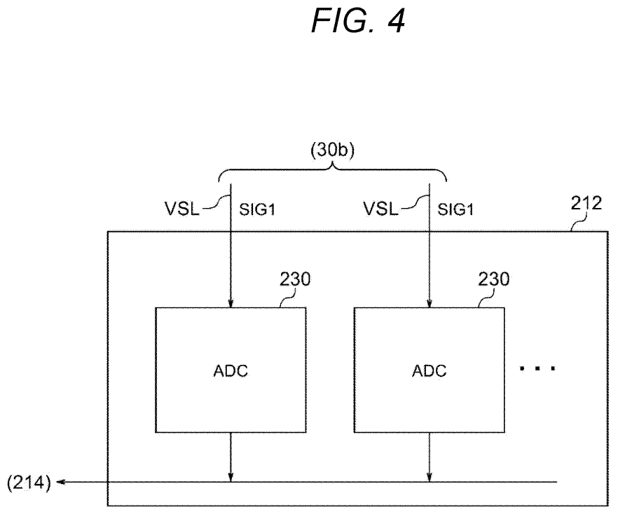

A configuration example of the AD converter 212 will be described with reference to FIG. 4. FIG. 4 is a block diagram illustrating a configuration example of the AD converter 212. The AD converter 212 is arranged for each of the gradation pixels 30b and 30b. The ADC 230 is provided for each column of the gradation pixels 30b. The ADC 230 converts the analog gradation luminance signal SIG1 supplied via the vertical signal line VSL into a digital signal. The ADC 230 supplies the generated digital signal to the image signal processor 214.

The image signal processor 214 executes predetermined signal processing such as correlated double sampling (CDS) processing and image recognition processing on the digital signal from the AD converter 212. The EVS signal processor 213 outputs the image data indicating the processing result and the detection signal to the recording section 120 (see FIG. 1) via the input/output interface 215.

### [Configuration Example of EVS Pixel]

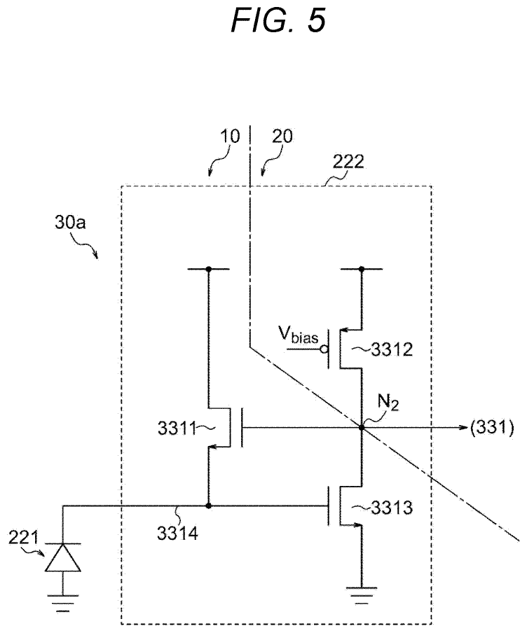

Here, the configuration example of the EVS pixel 30a will be described with reference to FIG. 5. FIG. 5 is a circuit diagram illustrating an example of a configuration of the EVS pixel 30a. As illustrated in FIG. 5, the EVS pixel 30a has a circuit configuration including a photoelectric conversion element 221, and an N-type transistor 3311 and an N-type transistor 3313 of a logarithmic conversion section 222. The P-type transistor 3312 is configured in the AFE array section 20 for EVS. Furthermore, the photoelectric conversion element 221 photoelectrically converts incident light to generate a charge. Note that the logarithmic conversion section 222 according to the present embodiment corresponds to a voltage conversion section.

The logarithmic conversion section 222 according to the present example has a circuit configuration including the N-type transistor 3311, the P-type transistor 3312, and the N-type transistor 3313. For example, metal-oxide-semiconductor (MOS) transistors are used as these transistors 3311 to 3313.

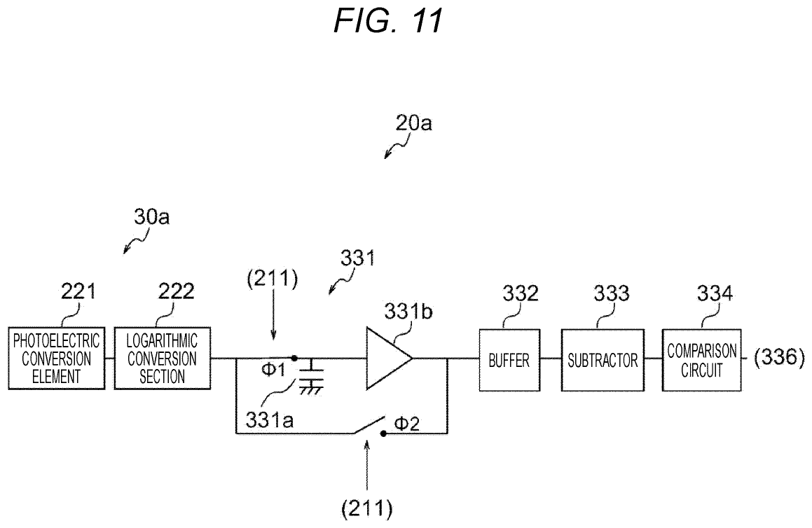

The N-type transistor 3311 is connected between the power supply line of the power supply voltage VDD and a signal input line 3314. The P-type transistor 3312 and the N-type transistor 3313 are connected in series between the power supply line of the power supply voltage VDD and the ground. Then, a gate electrode of the N-type transistor 3311 and an input terminal of the buffer 332 illustrated in FIG. 11 are connected to a connection node N2 common to the P-type transistor 3312 and the N-type transistor 3313.

A predetermined bias voltage Vbias is applied to a gate electrode of the P-type transistor 3312. Therefore, the P-type transistor 3312 supplies a constant current to the N-type transistor 3313. A photocurrent is input from a light receiving section 31 to a gate electrode of the N-type transistor 3313 through the signal input line 3314.

Drain electrodes of the N-type transistor 3311 and the N-type transistor 3313 are connected to a power supply side, and such a circuit is called a source follower. The photocurrent from the light receiving section 31 is converted into a logarithmic voltage signal VPR by the two source followers connected in a loop, and the logarithmic voltage signal is supplied from a node N2 to a pixel voltage holding section 331 as described later. Note that the pixel voltage holding section 331 according to the present embodiment corresponds to a signal holding section.

### [Configuration Example of Gradation Pixel]

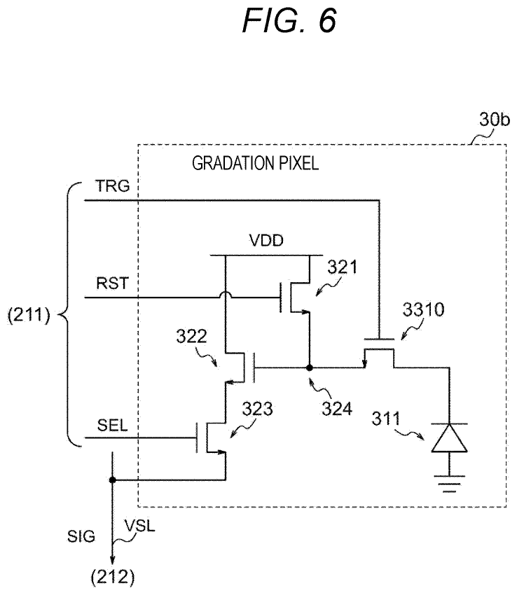

Here, the configuration example and control operation example of the gradation pixel 30b will be described with reference to FIG. 6. FIG. 6 is a diagram illustrating a circuit example of the gradation pixel 30b. As illustrated in FIG. 6, the gradation pixel 30b includes a reset transistor 321, an amplification transistor 322, a selection transistor 323, a floating diffusion layer 324, and a light receiving section 330.

For example, an N-type MOS transistor is used as the reset transistor 321, the amplification transistor 322, the selection transistor 323, and a transfer transistor 3310. Furthermore, a photoelectric conversion element 311 is disposed on the first layer element 201. All the elements other than the photoelectric conversion element 311 are disposed on the second layer element 202.

The photoelectric conversion element 311 photoelectrically converts incident light to generate electric charge. The electric charge photoelectrically converted by the photoelectric conversion element 311 is supplied from the photoelectric conversion element 311 to the floating diffusion layer 324 by the transfer transistor 3310. The electric charge supplied from the photoelectric conversion element 311 is accumulated in the floating diffusion layer 324. The floating diffusion layer 324 generates a voltage signal having a voltage value according to an amount of accumulated electric charges.

The amplification transistor 322 is connected in series with the selection transistor 323 between the power supply line of the power supply voltage VDD and the vertical signal line VSL. The amplification transistor 322 amplifies a voltage signal subjected to charge-voltage conversion by the floating diffusion layer 324.

A selection signal SEL is supplied from the row control section 211 to a gate electrode of the selection transistor 323. The selection transistor 323 outputs, in response to the selection signal SEL, the voltage signal amplified by the amplification transistor 322 to the AD converter 212 (see FIG. 2) via the vertical signal line VSL as the pixel signal SIG.

### (Parasitic Capacitance)

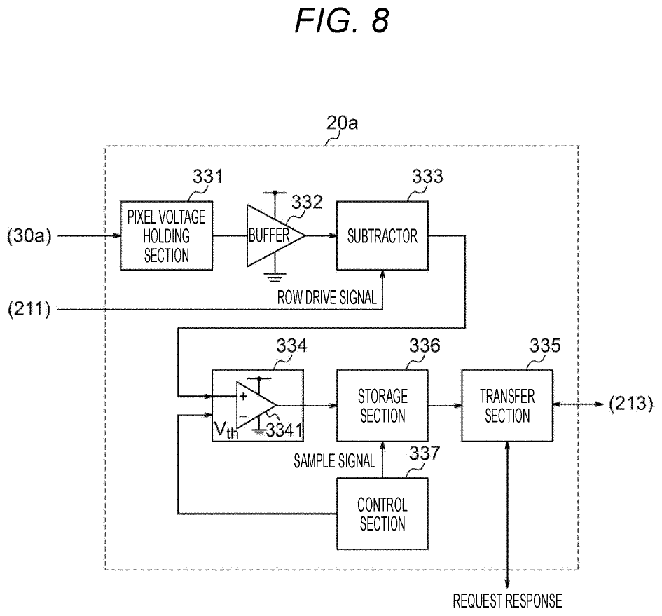

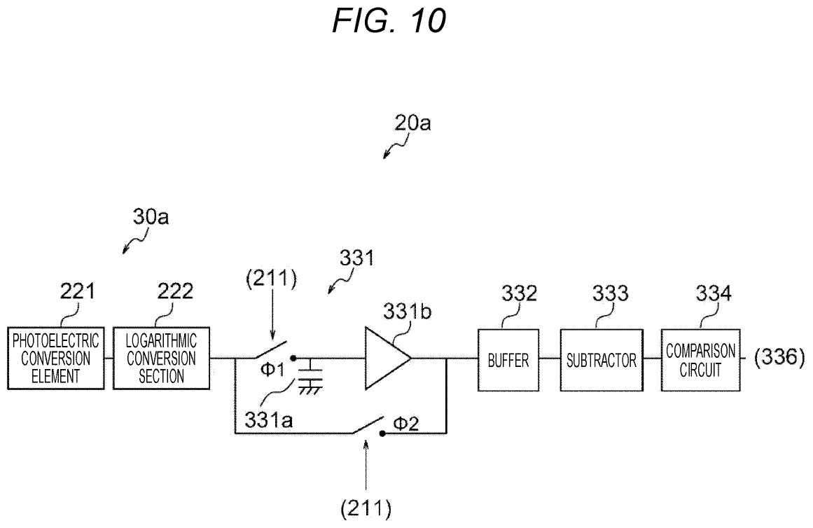

FIG. 7 is a diagram illustrating the parasitic capacitance Cs between the EVS pixel 30a and the vertical signal line VSL of the gradation pixel 30b. As illustrated in FIG. 7, parasitic capacitance Cs is generated between the gate control line of the N-type transistor 3312 of the EVS pixel 30a and the vertical signal line VSL of the gradation pixel 30b. Therefore, when the timing of conversion into the voltage signal VPR and output from the node N2 and the timing of AD conversion of the gradation pixel 30b overlap with each other, the magnitude of the pixel signal SIG1 fluctuates. For this reason, the AFE array section 20 for EVS according to the present embodiment includes a pixel voltage holding section 331 described later with reference to FIGS. 8 and 10.

FIG. 8 is a diagram illustrating a configuration example of the event detection section 20a of the AFE array section 20 for EVS. As illustrated in FIG. 8, the event detection section 20a includes the pixel voltage holding section 331, a buffer 332, a subtractor 333, a quantizer 334, a transfer section 335, a storage section 336 and a control section 337. Note that at least a part of the buffer 332, the subtractor 333, the quantizer 334, the transfer section 335, and the storage section 336 according to the present embodiment corresponds to the first circuit.

The pixel voltage holding section 331 holds the voltage signal VPR of the logarithmic conversion section 222 at the time of signal reading of the corresponding gradation pixel 30b, and cuts off the electrical connection between the buffer 332 and the EVS pixel 30a. On the other hand, in a case other than at the time of signal reading of the corresponding gradation pixel 30b, the corresponding gradation pixel is electrically connected to the buffer 332. That is, the pixel voltage holding section 331 supplies the voltage signal VPR of the logarithmic conversion section 222 to the buffer 332 in a case other than at the time of signal reading of the corresponding gradation pixel 30b. Note that details of the pixel voltage holding section 331 will be described later.

The buffer 332 buffers the voltage signal supplied from the logarithmic conversion section 222 and supplies the buffered voltage signal to the subtractor 333. A row drive signal is supplied from the row control section 211 to the subtractor 333. The subtractor 333 lowers the level of the voltage signal supplied from the buffer 332 in accordance with the row drive signal. Then, the subtractor 333 supplies the voltage signal whose level has been lowered to the quantizer 334. The quantizer 334 quantizes the voltage signal supplied from the subtractor 333 into a digital signal and outputs the digital signal to the transfer section 335 as a detection signal of an address event.

The transfer section 335 transfers the detection signal of the address event supplied from the quantizer 334 to the image signal processor 214 and the like. When an address event is detected, the transfer section 335 supplies the detection signal of the address event to the EVS signal processor 213 and the row control section 211.

Next, configuration examples of the subtractor 333 and the quantizer 334 will be described.

### (Configuration Example of Subtractor and Quantizer)

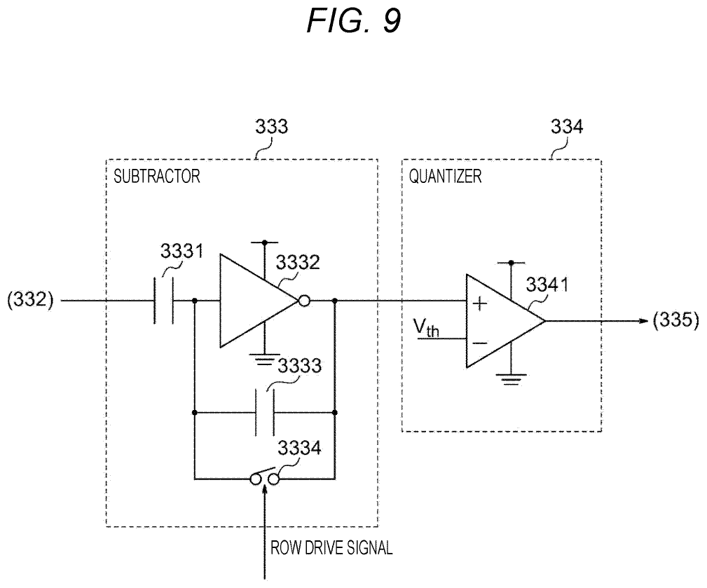

FIG. 9 is a circuit diagram illustrating an example of a configuration of the subtractor 333 and the quantizer 334. The subtractor 333 according to the present example has a configuration including a capacitive element 3331, an inverter circuit 3332, a capacitive element 3333, and a switch element 3334.

One end of the capacitive element 3331 is connected to an output terminal of the buffer 332 illustrated in FIG. 8, and the other end thereof is connected to an input terminal of the inverter circuit 3332. The capacitive element 3333 is connected in parallel to the inverter circuit 3332. The switch element 3334 is connected between both ends of the capacitive element 3333. The row drive signal is supplied from a second access control circuit 211b to the switch element 3334 as an on/off control signal. The switch element 3334 turns on or off a path connecting both ends of the capacitive element 3333 according to the row drive signal. The inverter circuit 3332 inverts the polarity of the voltage signal input via the capacitive element 3331.

In the subtractor 333 having the above configuration, when the switch element 3334 is turned on (closed), a voltage signal Vinit is input to a terminal of the capacitive element 3331 on a buffer 332 side, and a terminal on the opposite side serves as a virtual ground terminal. A potential of the virtual ground terminal is set to zero for convenience. At this time, when a capacitance value of the capacitive element 3331 is C1, a charge Qinit accumulated in the capacitive element 3331 is expressed by the following Formula (1). On the other hand, since both ends of the capacitive element 3333 are short-circuited, the capacitive element has no accumulated charges.

$$Qinit = C 1 \times Vinit \qquad ( 1 )$$

Next, considering a case where the switch element 3334 is turned off (open) and the voltage of the terminal of the capacitive element 3331 on the buffer 332 side changes to Vafter, a charge Qafter accumulated in the capacitive element 3331 is expressed by the following Formula (2).

$$Qafter = C 1 \times Vafter \qquad ( 2 )$$

On the other hand, when a capacitance value of the capacitive element 3333 is C2 and an output voltage is Vout, a charge Q2 accumulated in the capacitive element 3333 is expressed by the following Formula (3).

$$Q 2 = - C 2 \times Vout \qquad ( 3 )$$

At this time, since a total charge amount of the capacitive element 3331 and the capacitive element 3333 does not change, the following Formula (4) is established.

$$Qinit = Qafter + Q 2 \qquad ( 4 )$$

When Formulas (1) to (3) are substituted into Formula (4) and rearranged, the following Formula (5) is obtained.

$$Vout = - ( C 1 / C 2 ) \times ( Vafter - Vinit ) \qquad ( 5 )$$

Formula (5) represents a subtraction operation of the voltage signal, and the gain of the subtraction result is C1/C2. Since it is generally desired to maximize the gain, it is preferable to design C1 larger and C2 smaller. On the other hand, when C2 is too small, kTC noise increases, and noise characteristics may deteriorate. Therefore, the reduction in capacitance of C2 is limited to a range in which noise can be tolerated. Furthermore, since the event detection section 20a including the subtractor 333 is mounted for each EVS pixel 30a, the capacitive element 3331 and the capacitive element 3333 have area restrictions. The capacitance values C1 and C2 of the capacitive elements 3331 and 3333 are determined in consideration of these factors.

In FIG. 9, the quantizer 334 includes a comparator 3341. The comparator 3341 uses the output signal of the inverter circuit 3332, that is, the voltage signal from the subtractor 333 as a non-inverting (+) input, and uses a predetermined threshold voltage Vth as an inverting (−) input. Then, the comparator 3341 compares the voltage signal from the subtractor 333 with the predetermined threshold voltage Vth, and outputs a signal indicating a comparison result to the transfer section 335 as the detection signal of an address event.

FIG. 10 is a circuit diagram illustrating a configuration example of the pixel voltage holding section 331. As illustrated in FIG. 10, the pixel voltage holding section 331 includes a capacitance 331a, a buffer 331b, a first switching element Φ1, and a first switching element Φ2.

The first switching element Φ1 is, for example, an NMOS transistor, and enters a conductive state when the row control section 211 applies a high-level signal, and enters a non-conductive state when the row control section applies a low-level signal. One end of the first switching element Φ1 is connected to the logarithmic conversion section 222, and the other end is connected to one end of the capacitance 331a and one end of the buffer 331b.

The capacitance 331a is, for example, a capacitor, and one end thereof is connected to the other end of the first switching element Φ1 and one end of the buffer 331b. The other end of the capacitance 331a is connected to a predetermined low potential (the ground potential).

The buffer 331b is, for example, a voltage follower circuit, and is a feedback circuit having an amplification degree of 1. The other end of the buffer 331b is connected to one end of the buffer 332.

The second switching element Φ2 is, for example, an NMOS transistor, and enters a conductive state when the row control section 211 applies a high-level signal, and enters a non-conductive state when the row control section applies a low-level signal. One end of the first switching element Φ2 is connected to the logarithmic conversion section 222, and the other end is connected to one end of the buffer 332 and the other end of the buffer 331b.

FIG. 11 is a diagram illustrating a sampling operation of the pixel voltage holding section 331. As illustrated in FIG. 11, the row control section 211 brings the first switching element Φ1 into a conductive state and brings the second switching element Φ2 into a non-conductive state. At the time of sampling operation, a charge according to the voltage signal VPR of the logarithmic conversion section 211 is accumulated in the capacitance 331a, and the voltage signal VPR is supplied to the buffer 332. As described above, during the sampling operation, the voltage signal VPR of the logarithmic conversion section 211 is supplied to the buffer 332, and charges corresponding to the voltage signal VPR are accumulated. In other words, during the sampling operation, the potential corresponding to the charge accumulated in the capacitance 331a is supplied to the buffer 332 via the buffer 331b.

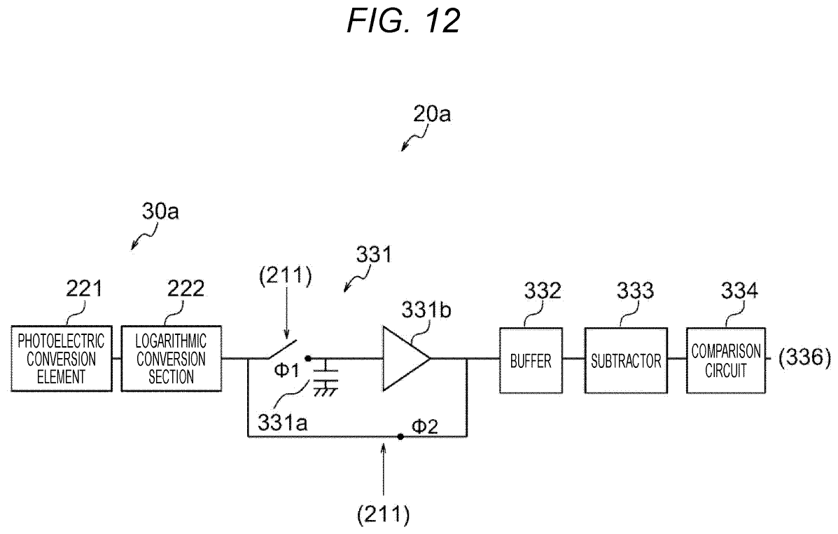

FIG. 12 is a diagram illustrating a hold operation of the pixel voltage holding section 331. As illustrated in FIG. 12, the row control section 211 brings the first switching element Φ1 into the non-conductive state and brings the second switching element Φ2 into the conductive state. During the hold operation, a potential corresponding to the charge accumulated during the sampling operation is supplied to the buffer 332.

Furthermore, a potential corresponding to the charge accumulated in the capacitance 331a is applied to the control line of the N-type transistor 3311 (see FIG. 5) of the logarithmic conversion section 222 via the buffer 331b. Therefore, the fluctuation of the voltage signal VPR of the logarithmic conversion section 222 is suppressed to the output potential of the buffer 331b, and the voltage fluctuation of the parasitic capacitance Cs (see FIG. 7) to the vertical signal line VLS (see FIG. 4) is suppressed. Note that the row control section 211 can also suppress the application of the bias voltage Vbais (see FIG. 5) of the logarithmic conversion section 222 at the time of the hold operation. Therefore, the voltage signal VPR of the logarithmic conversion section 222 can also be suppressed. Furthermore, the pixel voltage holding section 331 that performs a hold operation is determined for each vertical signal line VSL. Therefore, during the period in which the analog-digital conversion of the output signal via the vertical signal line VSL is performed, the pixel voltage holding section 331 of the EVS pixel 30a in the predetermined range from the vertical signal line VSL suppresses the fluctuation of the voltage signal VPR of the corresponding logarithmic conversion section 222.

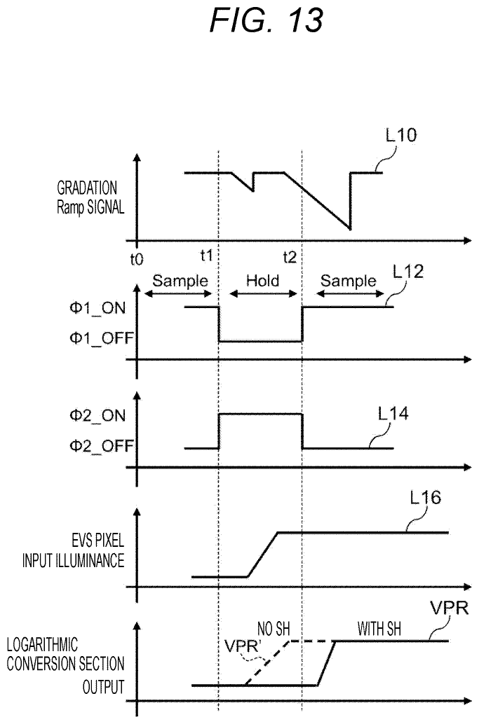

FIG. 13 is a diagram illustrating a control example of the pixel voltage holding section 331 by the row control section 211. A gradation Ramp signal L10 of the AD converter 212, a first control signal L12 of the first switching element Φ1, and a second control signal L14 of the second switching element Φ2 are illustrated in order from the top. Furthermore, the illuminance L16 with which the EVS pixel 30a is irradiated and the voltage signal VPR of the logarithmic conversion section 211 are illustrated.

According to the present embodiment, the row control section 211 causes a hold operation to be performed with a readout period of a signal to the vertical signal line VLS (see FIG. 4) in the AD converter 212 as a hold period of the pixel voltage holding section 331. In this case, since the plurality of ADCs 230 (see FIG. 4) are sequentially driven, the hold operation is performed on the pixel voltage holding section 331 of the EVS pixel 30a in the range of capacitive coupling with the vertical signal line VLS connected to the ADC 230 being driven.

At time t0, since the ADC 230 (see FIG. 4) does not perform the AD conversion, the pixel voltage holding section 331 is in the sampling period, and the first control signal L12 becomes the high level and the second control signal L14 becomes the low level. Therefore, the voltage signal VPR of the logarithmic conversion section 211 is sampled by the capacitance 331a of the pixel voltage holding section 331 and is output to the buffer 332.

Next, at time t1, since the ADC 230 (see FIG. 4) starts conversion of AD conversion, the row control section 211 sets the first control signal L12 to the low level and the second control signal L14 to the high level. Therefore, the pixel voltage holding section 331 starts the hold operation. For this reason, even if the illuminance L16 with which the EVS pixel 30a is irradiated fluctuates, the fluctuation of the voltage signal VPR of the logarithmic conversion section 211 is suppressed. Between time t1 and time t2, the pixel voltage holding section 331 holds the voltage signal VPR at time t1 and outputs the signal to the buffer 332. Therefore, the potential corresponding to the charge accumulated during the sampling operation at time t1 is supplied to the buffer 332.

Furthermore, a potential corresponding to the charge accumulated during the sampling operation at the time t1 is applied to the control line of the N-type transistor 3311 (see FIG. 5) of the logarithmic conversion section 222 via the buffer 331b. Therefore, the fluctuation of the voltage signal VPR of the logarithmic conversion section 222 is suppressed to the output potential of the buffer 331b, and the voltage fluctuation of the parasitic capacitance Cs (see FIG. 7) to the vertical signal line VLS (see FIG. 4) is suppressed.

As described above, during the conversion period of the AD conversion, the fluctuation of the voltage signal VPR is suppressed, and the voltage fluctuation of the parasitic capacitance Cs to the vertical signal line VLS is suppressed. On the other hand, the voltage signal VPR′ indicates the voltage signal of the logarithmic conversion section 211 in a case where the pixel voltage holding section 331 continues the sampling operation. In this case, since the potential on the control line of the N-type transistor 3311 (see FIG. 5) of the logarithmic conversion section 222 fluctuates, a voltage fluctuation of the parasitic capacitance Cs to the vertical signal line VLS occurs.

Next, at time t2, since the ADC 230 (see FIG. 4) performs AD conversion of the signal level, even if the voltage signal VPR fluctuates, the influence on the AD conversion is limited. For this reason, similarly to time t0, the pixel voltage holding section 331 becomes the sampling period, the first control signal L12 becomes the high level, and the second control signal L14 becomes the low level. Therefore, the voltage signal VPR of the logarithmic conversion section 211 is sampled by the capacitance 331a of the pixel voltage holding section 331 and is output to the buffer 332. At this time, since the illuminance L16 is higher than the time t1, the logarithmic conversion section 211 outputs the voltage signal VPR corresponding to the illuminance L16. Note that, in the present embodiment, in the AD conversion of the signal level, the pixel voltage holding section 331 performs a sampling operation, but the present invention is not limited thereto. For example, a period corresponding to the AD conversion of the signal level may be used as the hold period of the pixel voltage holding section 331. Therefore, it is possible to obtain a signal in which fluctuation is further suppressed.

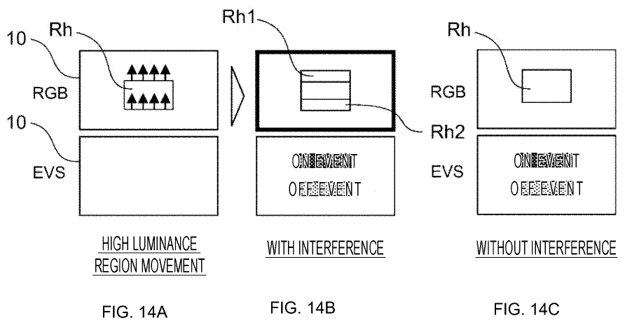

FIG. 14 is a diagram schematically illustrating a case where the sampling operation is continued during the conversion period of the AD conversion and a case where the pixel voltage holding section 331 performs the hold operation instead of the sampling operation. In FIGS. (a) to (c), gradation pixels of the pixel array section 10 are indicated by RGB, and EVS pixels are indicated by EVS.

FIG. (a) illustrates an example in which a high luminance region Rh moves in the arrow direction. FIG. (b) illustrates a case where the pixel voltage holding section 331 continues the sampling operation. Since there is a luminance change, the logarithmic conversion section 211 of the EVS pixel 30a decreases the voltage signal VPR in a region where the luminance is reduced. This region is detected as an occurrence region of an OFF event by the event detection section 20a (see FIG. 7). On the other hand, the logarithmic conversion section 211 of the EVS pixel 30a increases the voltage signal VPR in a region where the luminance has increased. This region is detected as an occurrence area of an ON event by the event detection section 20a (see FIG. 7).

Since the pixel voltage holding section 331 continues the sampling operation, the output signal of the gradation pixel in FIG. (b) is affected by the fluctuation of the voltage signal VPR, and in the region where the OFF event occurs, a region Rh2 occurs as an afterimage although there is originally no image signal. On the other hand, in the ON event occurrence region, although the image signal originally has high luminance, a region Rh1 in which the luminance decreases due to the influence of the fluctuation of the voltage signal VPR is generated.

On the other hand, in FIG. (c), since the pixel voltage holding section 331 performs the hold operation instead of the sampling operation, the influence of the fluctuation of the voltage signal VPR is suppressed, the afterimage region Rh2 disappears in the OFF event occurrence region, and the luminance of the region Rh1 becomes the high luminance value in the ON event occurrence region. As described above, the pixel voltage holding section 331 sets the hold operation to the conversion period of the AD conversion, whereby the fluctuation of the voltage signal VPR is suppressed, and the voltage fluctuation of the parasitic capacitance Cs to the vertical signal line VLS is suppressed.

As described above, according to the present embodiment, the EVS pixel 30a and the gradation pixel 30b are mixed in the pixel array section 10, and the pixel voltage holding section 331 corresponding to the EVS pixel 30a suppresses the fluctuation of the voltage signal VPR of the logarithmic conversion section 222 during the AD conversion period of the gradation pixel 30b by the pixel voltage holding section 331 corresponding to the EVS pixel 30a. Therefore, it is possible to suppress voltage fluctuation in the AD conversion period of the gradation pixel 30b to the vertical signal line VLS due to the parasitic capacitance Cs between the output signal line of the logarithmic conversion section 222 and the vertical signal line VLS. Therefore, the fluctuation of the luminance signal of the gradation pixel 30b is suppressed. In this manner, the voltage of the EVS pixel 30a is temporarily held, and the voltage of the EVS pixel 30a is output at the timing when the gradation pixel 30b has not undergone AD change or the like, whereby interference (noise) with AD conversion of the gradation pixel 30b can be suppressed.

### Modification 1 of First Embodiment

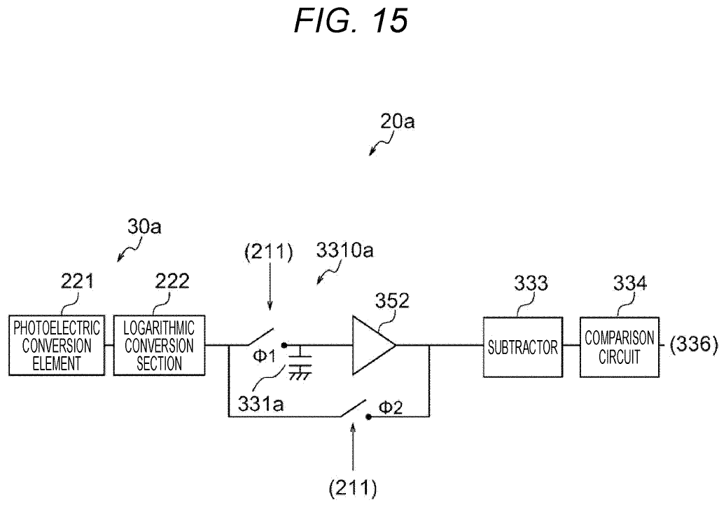

FIG. 15 is a diagram illustrating a configuration example of a pixel voltage holding section 3310a according to Modification 1 of the first embodiment. The pixel voltage holding section 3310a according to Modification 1 of the first embodiment includes a buffer 352 instead of the buffer 331b. The buffer 352 has a function of combining the buffer 331b and the buffer 332. Therefore, the event detection section 20a (see FIG. 7) can be further downsized.

### Modification 2 Of First Embodiment

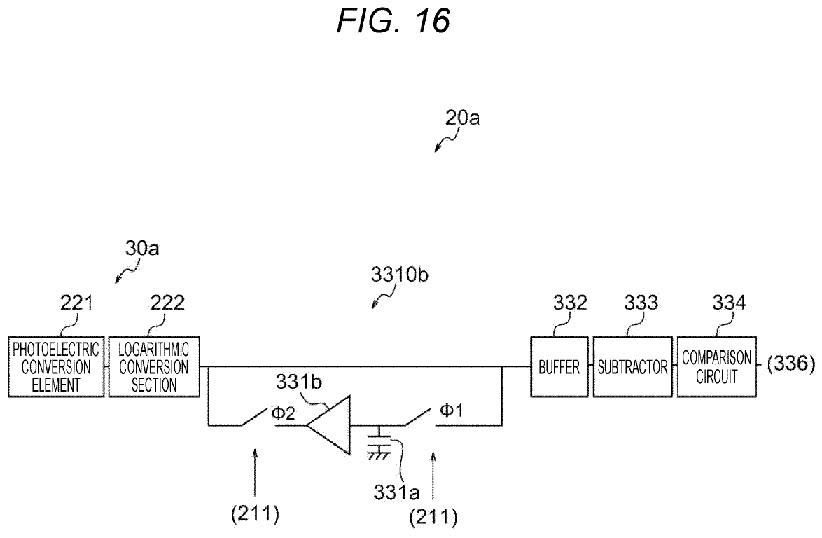

FIG. 16 is a diagram illustrating a configuration example of a pixel voltage holding section 3310b according to Modification 2 of the first embodiment. In the pixel voltage holding section 3310b according to Modification 2 of the first embodiment, one end of the first switching element Φ1 is connected to the buffer 332, and the other end is connected to the input terminal of the buffer 331b. Furthermore, one end of the second switching element Φ2 is connected to the logarithmic conversion section 222, and the other end is connected to the output terminal of the buffer 331b. One end of the capacitance 331a is connected to an input terminal of the buffer 331b. The logarithmic conversion section 222 and the buffer 332 are connected by wiring. This connection also has an effect equivalent to that of the pixel voltage holding section 331 according to the first embodiment. Note that the row control section 211 can also suppress the application of the bias voltage Vbais (see FIG. 5) of the logarithmic conversion section 222 in the hold period.

### Modification 3 Of First Embodiment

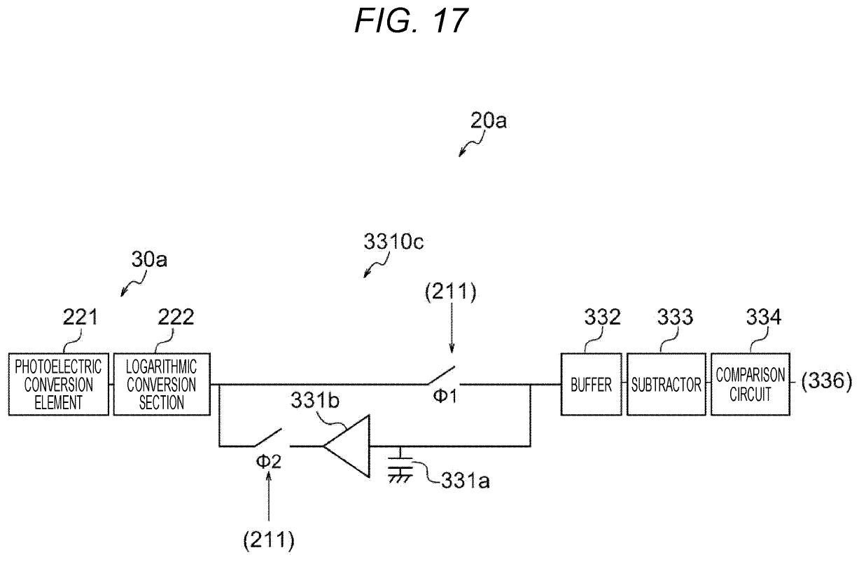

FIG. 17 is a diagram illustrating a configuration example of a pixel voltage holding section 3310c according to Modification 3 of the first embodiment. In the pixel voltage holding section 3310c according to Modification 3 of the first embodiment, one end of the first switching element Φ1 is connected to the buffer 332, and the other end is connected to the logarithmic conversion section 222. Furthermore, one end of the second switching element Φ2 is connected to the logarithmic conversion section 222, and the other end is connected to the output terminal of the buffer 331b. An input terminal of the buffer 331b is connected to the buffer 332 and one end of the capacitance 331a, and the other end of the capacitance 331a is connected to the ground. This connection also has an effect equivalent to that of the pixel voltage holding section 331 according to the first embodiment.

### Modification 4 Of First Embodiment

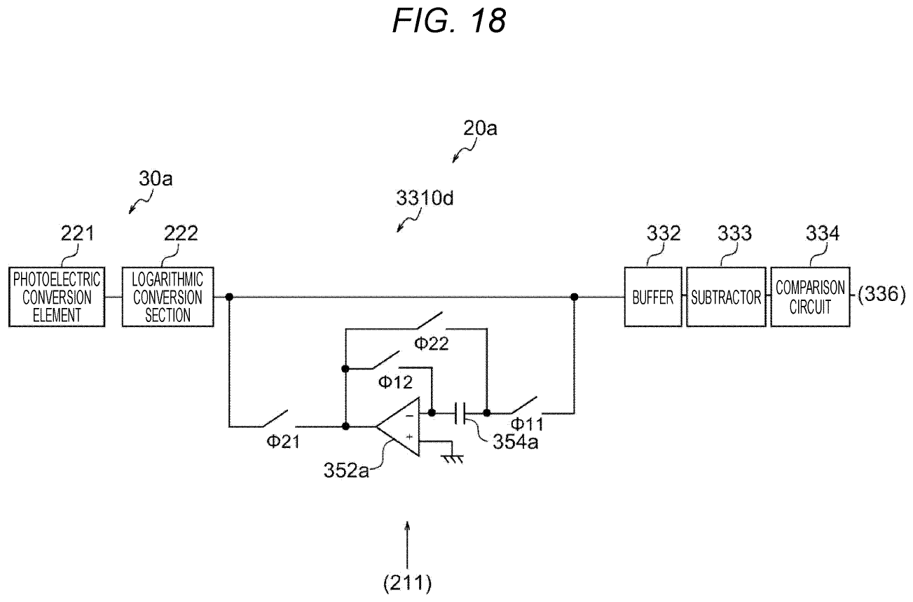

FIG. 18 is a diagram illustrating a configuration example of a pixel voltage holding section 3310d according to Modification 4 of the first embodiment. In the pixel voltage holding section 3310d according to Modification 4 of the first embodiment, an operational amplifier 352a is used instead of the buffer 331b. The pixel voltage holding section 3310d further includes an 11th switching element Φ11, a 12th switching element Φ12, a 21st switching element Φ21, a 22nd switching element Φ22, and a capacitance 354a. 11 switching elements Φ11, the 12th switching element Φ12, the 21st switching element Φ21, and the 22nd switching element Φ22 are, for example, NMOS transistors.

One end of the 21st switching element Φ21 is connected to the logarithmic conversion section 222, and the other end is connected to the output terminal of the operational amplifier 352a. Furthermore, one end of the 12th switching element Φ12 is connected to the output terminal of the operational amplifier 352a, and the other end is connected to the inverting input terminal of the operational amplifier 352a. Furthermore, one end of the 22nd switching element Φ22 is connected to the output terminal of the operational amplifier 352a, and the other end is connected to one end of the capacitance 354a and one end of the 11th switching element Φ11. The other end of the 11th switching element Φ11 is connected to the buffer 332. Furthermore the other end of the capacitance 354a is connected to the inverting input terminal of the operational amplifier 352a, and the non-inverting input terminal of the operational amplifier 352a is connected to the ground. The logarithmic conversion section 222 and the buffer 332 are connected by wiring.

In the hold operation, the 11th switching element Φ11 and the 12th switching element Φ12 are in a connected state, and the 21st switching element Φ21 and the 22nd switching element Φ22 are in a disconnected state. In the sampling operation, the 11th switching element Φ11 and the 12th switching element Φ12 are brought into a disconnected state, and the 21st switching element Φ21 and the 22nd switching element Φ22 are brought into a connected state. Therefore, a potential corresponding to the accumulated charge of the capacitance 354a is applied from the output terminal of the operational amplifier 352a to the control line of the N-type transistor 3311 (see FIG. 5) of the logarithmic conversion section 222. Therefore, the fluctuation of the voltage signal VPR of the logarithmic conversion section 222 is suppressed to the output potential of the output terminal of the operational amplifier 352a, and the voltage fluctuation of the parasitic capacitance Cs (see FIG. 7) to the vertical signal line VLS (see FIG. 4) is suppressed. Note that the row control section 211 can also suppress the application of the bias voltage Vbais (see FIG. 5) of the logarithmic conversion section 222 at the time of the hold operation. This connection also has an effect equivalent to that of the pixel voltage holding section 331 according to the first embodiment.

### Modification 5 Of First Embodiment

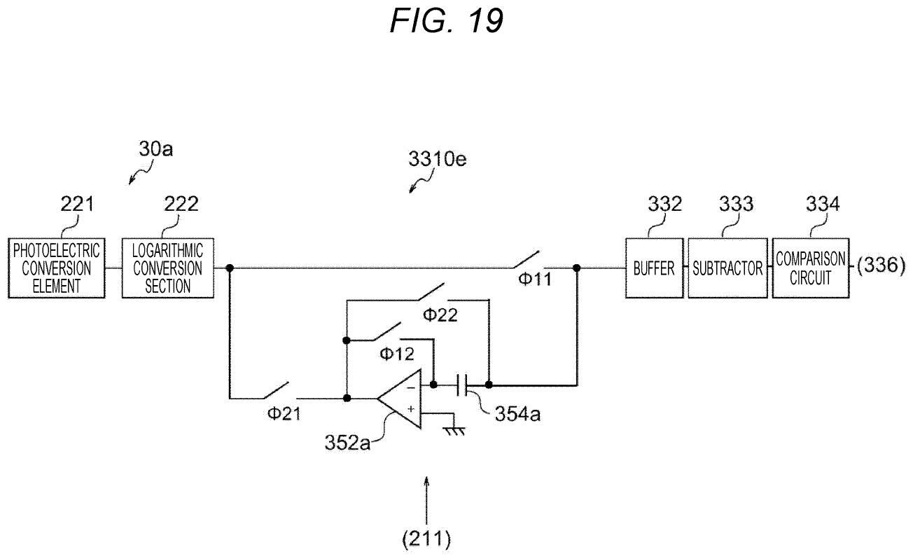

FIG. 19 is a diagram illustrating a configuration example of a pixel voltage holding section 3310e according to Modification 5 of the first embodiment. The pixel voltage holding section 3310e according to Modification 5 of the first embodiment is different from the pixel voltage holding section 3310d according to Modification 4 of the first embodiment in that one end of an 11th switching element Φ11 is connected to the logarithmic conversion section 222 and the other end is connected to the buffer 332.

In the hold operation, the 11th switching element Φ11 and the 12th switching element Φ12 are in a connected state, and the 21st switching element Φ21 and the 22nd switching element Φ22 are in a disconnected state. In the sampling operation, the 11th switching element Φ11 and the 12th switching element Φ12 are brought into a disconnected state, and the 21st switching element Φ21 and the 22nd switching element Φ22 are brought into a connected state. Therefore, a potential corresponding to the accumulated charge of the capacitance 354a is applied from the output terminal of the operational amplifier 352a to the control line of the N-type transistor 3311 (see FIG. 5) of the logarithmic conversion section 222. Therefore, the fluctuation of the voltage signal VPR of the logarithmic conversion section 222 is suppressed to the output potential of the output terminal of the operational amplifier 352a, and the voltage fluctuation of the parasitic capacitance Cs (see FIG. 7) to the vertical signal line VLS (see FIG. 4) is suppressed.

### Second Embodiment

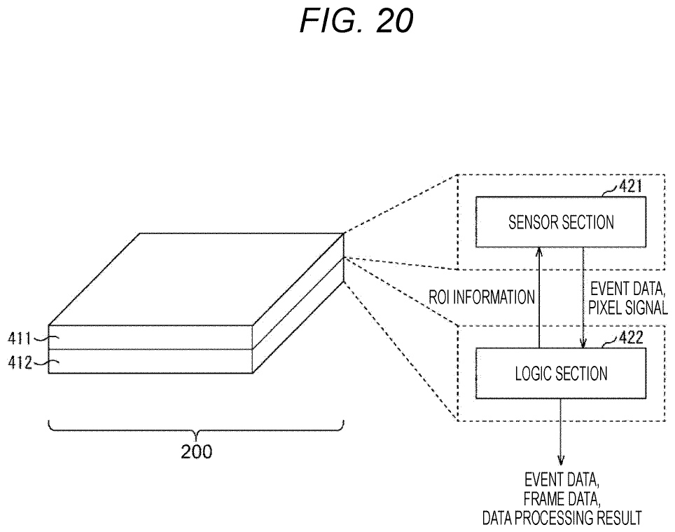

FIG. 20 is a diagram illustrating a configuration example of a second embodiment of the solid-state imaging device to which the present technology is applied. In a photodetection element 200 according to the second embodiment, an EVS pixel that receives light for event detection and a gradation pixel that receives light for generating an image of a region of interest are formed on the same chip.

The photodetection element 200 in FIG. 20 includes one chip in which a sensor die (substrate) 411 as a plurality of dies (substrates) and a logic die 412 are stacked. (A circuit as) A sensor section 421 is configured in the sensor die 411, and a logic section 422 is configured in the logic die 412.

The sensor section 421 generates event data similarly to the pixel array section 10 (FIG. 3) described above. That is, the sensor section 421 includes an EVS pixel 30a that photoelectrically converts incident light to generate an electrical signal, and generates event data representing occurrence of an event that is a change in the electrical signal of the pixel.

Furthermore, the sensor section 421 generates a pixel signal similarly to the pixel array section 10 (FIG. 3) described above. That is, the sensor section 421 includes a gradation pixel 30b that photoelectrically converts incident light to generate an electrical signal, performs imaging in synchronization with a vertical synchronization signal, and outputs frame data that is image data in a frame format.

The sensor section 421 can output the event data or the pixel signal independently, and can also output the pixel signal of a region of interest on the basis of ROI information input from the logic section 422 on the basis of the generated event data.

The logic section 422 controls the sensor section 421 as necessary. Furthermore, the logic section 422 performs various types of data processing such as data processing of generating frame data according to the event data from the sensor section 421 and image processing for frame data from the sensor section 421 or frame data generated according to the event data from the sensor section 421, and outputs the event data, the frame data, and a data processing result obtained by performing the various types of data processing.

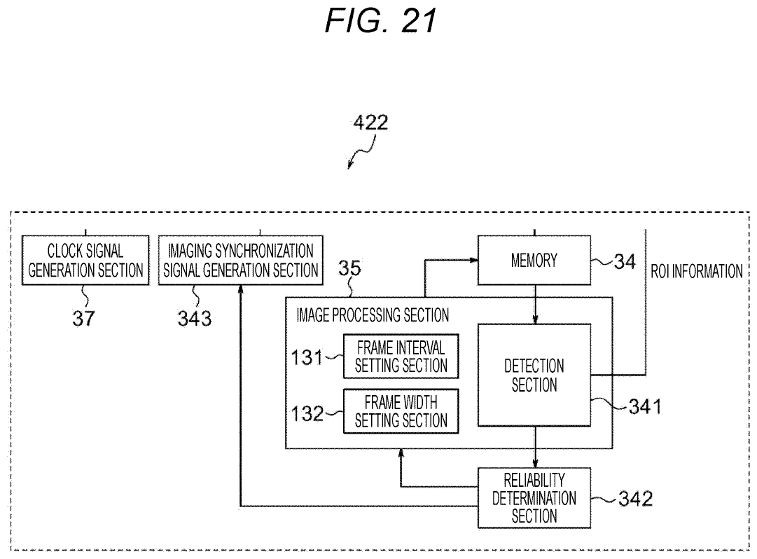

FIG. 21 is a diagram illustrating a configuration example of the logic section 422. As illustrated in FIG. 21, the logic section 422 includes, for example, a memory 34, an image processing section 35, a clock signal generation section 37, a detection section 341, a reliability determination section 342, an imaging synchronization signal generation section 343, and the like. Similarly to the detection section 133 of the second embodiment, the detection section 341 specifies an object as a detection target by image recognition using frame data stored in the memory 34, and extracts contour information of the object. Then, the image processing section 35 sets a region including the specified object as a region of interest, and outputs information specifying the region of interest to the drive section 432 as ROI information. The reliability determination section 342 determines the reliability of object detection on the basis of the detection rate supplied from the detection section 341, and controls the frame section (frame volume) in which the memory 34 accumulates event data.

The imaging synchronization signal generation section 343 generates an imaging synchronization signal in accordance with the imaging cycle control signal from the reliability determination section 342, and outputs the imaging synchronization signal to an input section 214 of a CIS chip 312. A clock signal (master clock) is supplied from the clock signal generation section 37 to the imaging synchronization signal generation section 343. A frame interval setting section 131 sets a frame interval in accordance with, for example, a user's operation or the like, and supplies the frame interval to the memory 34. The frame interval represents an interval between frames of frame data generated according to event data, and the frame interval can be specified and set by time or the number of pieces of event data. Here, the frame interval set by the frame interval setting section 131 is also referred to as a set frame interval.

A frame width setting section 132 sets the frame width according to, for example, a user's operation and supplies the frame width to the memory 34. The frame width represents the time width of the event data used for generating the frame data of one frame, and the frame width can be specified and set by the time or the number of pieces of event data, similarly to the frame interval.

Note that a part of the sensor section 421 can be configured as the logic die 412. Furthermore, a part of the logic section 422 can be configured in the sensor die 411.

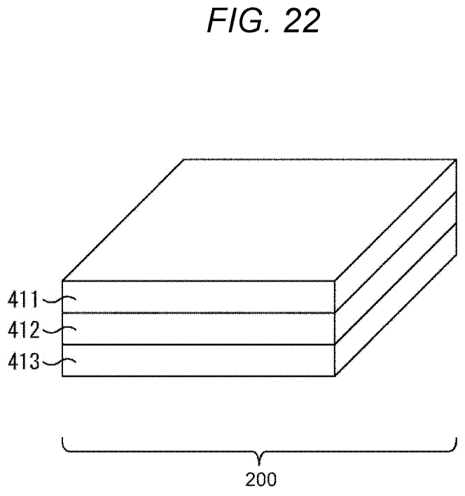

FIG. 22 is a diagram illustrating a structure example of three layers. Furthermore, for example, in a case where a memory having a large capacitance is provided as the memory 34 or the memory included in the image processing section 321, as illustrated in FIG. 22, the photodetection element 200 can include three layers in which another logic die 413 is stacked in addition to the sensor die 411 and the logic die 412. Of course, it may be configured by stacking four or more layers of dies (substrates).

### <Configuration Example of Sensor Section 421>

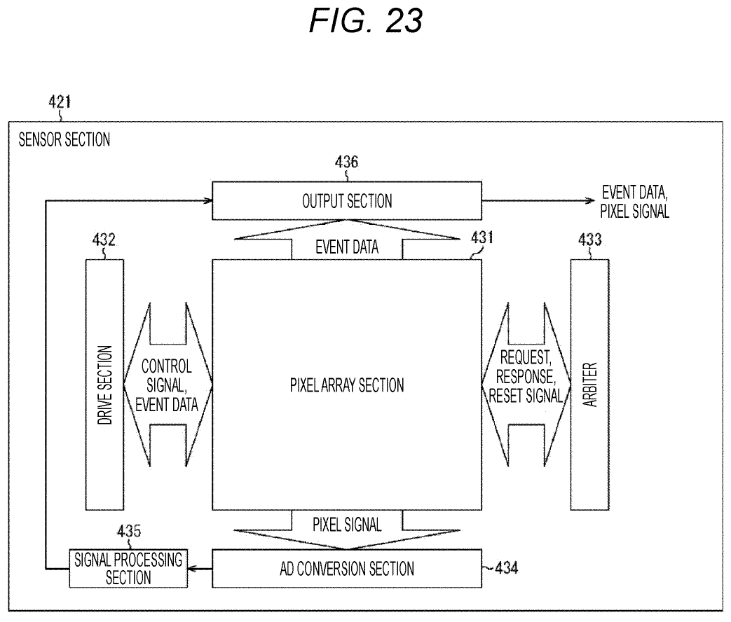

FIG. 23 is a block diagram illustrating a configuration example of the sensor section 421 in FIG. 20. The sensor section 421 includes a pixel array section 431, a drive section 432, an arbiter 433, an AD conversion section 434, a signal processing section 435, and an output section 436. It is connected to an inverting input terminal of an operational amplifier 352a.

The pixel array section 431 is configured by arranging a plurality of pixels (see FIG. 3) in a two-dimensional lattice. Furthermore, the event detection section 20a (see FIG. 7) corresponding to the EVS pixel 30b (see FIG. 3) is also configured in the pixel array section 431.

In a case where a change exceeding a predetermined threshold (including a change greater than or equal to the threshold as necessary) occurs in (a voltage corresponding to) a photocurrent as an electric signal generated by photoelectric conversion of the EVS pixel 30b, the pixel array section 431 detects the change in the photocurrent as an event.

In a case where the event is detected, the pixel array section 431 outputs a request for requesting the output of event data representing the occurrence of the event to the arbiter 433. Then, in a case where the pixel array section 431 receives a response representing permission for the output of the event data from the arbiter 433, the pixel array section outputs the event data to the drive section 432 and the output section 436. Moreover, the pixel array section 431 outputs the electric signal of the EVS pixel 30b in which the event is detected to the AD conversion section 434 as a pixel signal.

The drive section 432 drives the pixel array section 431 by supplying a control signal to the pixel array section 431. For example, the drive section 432 drives the EVS pixel 30b in which the event data is output from the pixel array section 431, and supplies (outputs) the pixel signal of the EVS pixel 30b to the AD conversion section 434.

The arbiter 433 arbitrates a request for requesting the output of the event data from the pixel array section 431, and returns a response representing permission or non-permission of the output of the event data to the pixel array section 431. Furthermore, after outputting a response representing permission of the output of the event data, the arbiter 433 outputs a reset signal for resetting event detection to the pixel array section 431.

In the ADC of each column, the AD conversion section 434 performs AD conversion on the pixel signal of a pixel 451 of a pixel block 441 of the column, and supplies the pixel signal to the signal processing section 435. Note that the AD conversion section 434 can perform CDS together with AD conversion of the pixel signal.

The signal processing section 435 performs predetermined signal processing such as black level adjustment processing and gain adjustment processing on the pixel signals sequentially supplied from the AD conversion section 434, and supplies the pixel signals to the output section 436.

The output section 436 performs the similar processing to the output section 36 and the output section 217 of a third embodiment. That is, the output section 436 performs necessary processing on the pixel signal and the event data, and supplies the pixel signal and the event data to the logic section 422 (FIG. 20).

The pixel array section 431 further includes an event detection section 20a (see FIG. 8) and a pixel signal generation section 252 (not illustrated). The EVS pixel 30a (see FIG. 3) receives incident light from a subject and photoelectrically converts the incident light to generate a photocurrent as an electric signal. The EVS pixel 30a supplies the photocurrent to the event detection section 20a under the control of the drive section 432.

Under the control of the drive section 432, the event detection section 20a detects a change in photocurrent from each of the EVS pixels 30a exceeding a predetermined threshold as an event. In a case where the event is detected, the event detection section 20a (see FIG. 8) supplies a request for requesting the output of event data representing the occurrence of the event to the arbiter 433 (FIG. 22). Then, when receiving a response indicating that the output of the event data is permitted in response to the request from the arbiter 433, the event detection section 20a outputs the event data to the drive section 432 and the output section 436.

In a case where an event is detected in the event detection section 20a, the pixel signal generation section 252 generates a pixel signal corresponding to the photocurrent of the gradation pixel 30b (see FIG. 3) under the control of the drive section 432, and supplies the generated pixel signal to the AD conversion section 434 (FIG. 22) via the vertical signal line VSL.

As described above, in the sensor section 421 (FIG. 20), an event is detected by one or more EVS pixels 30a and the event detection section 20a, and event data is generated. The generated event data is supplied to the logic section 422, and the region of interest is determined. Then, the ROI information of the region of interest is supplied from the logic section 422 to the sensor section 421, an image signal is generated by the gradation pixel 30b corresponding to the region of interest, and is sequentially output to the vertical signal line VSL. The pixel signal output to the vertical signal line VSL is supplied to the AD conversion section 434 and subjected to AD conversion. At this time, while the pixel voltage holding section 331 (see FIG. 8) corresponding to the EVS pixel 30a is in the AD conversion period of the gradation pixel 30b, the corresponding pixel voltage holding section 331 of the EVS pixel 30a suppresses fluctuation of the voltage signal VPR of the logarithmic conversion section 222. Therefore, it is possible to suppress voltage fluctuation in the AD conversion period of the gradation pixel 30b to the vertical signal line VLS due to the parasitic capacitance Cs between the output signal line of the logarithmic conversion section 222 and the vertical signal line VLS.

### APPLICATION EXAMPLE

The technology according to the present disclosure can be applied to various products. For example, the technology according to the present disclosure may also be realized as a device mounted on any type of mobile body such as an automobile, an electric automobile, a hybrid electric automobile, a motorcycle, a bicycle, a personal mobility, an airplane, a drone, a ship, a robot, a building machine, or an agricultural machine (tractor).

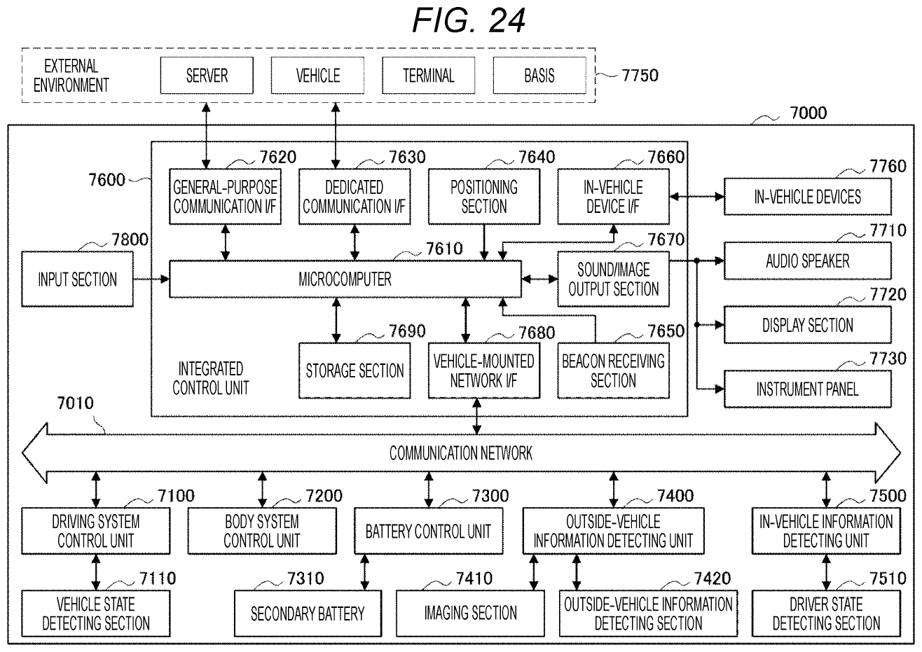

FIG. 24 is a block diagram illustrating a schematic configuration example of a vehicle control system 7000 as an example of a mobile body control system to which the technology according to the present disclosure can be applied. The vehicle control system 7000 includes a plurality of electronic control units connected to each other via a communication network 7010. In the example illustrated in FIG. 24, the vehicle control system 7000 includes a driving system control unit 7100, a body system control unit 7200, a battery control unit 7300, an outside-vehicle information detecting unit 7400, an in-vehicle information detecting unit 7500, and an integrated control unit 7600. The communication network 7010 connecting the plurality of control units to each other may, for example, be a vehicle-mounted communication network compliant with an arbitrary standard such as controller area network (CAN), local interconnect network (LIN), local area network (LAN), FlexRay (registered trademark), or the like.

Each of the control units includes: a microcomputer that performs arithmetic processing according to various kinds of programs; a storage section that stores the programs executed by the microcomputer, parameters used for various kinds of operations, or the like; and a driving circuit that drives various kinds of control target devices. Each of the control units further includes: a network interface (I/F) for performing communication with other control units via the communication network 7010; and a communication I/F for performing communication with a device, a sensor, or the like within and without the vehicle by wire communication or radio communication. A functional configuration of the integrated control unit 7600 illustrated in FIG. 24 includes a microcomputer 7610, a general-purpose communication I/F 7620, a dedicated communication I/F 7630, a positioning section 7640, a beacon receiving section 7650, an in-vehicle device I/F 7660, a sound/image output section 7670, a vehicle-mounted network I/F 7680, and a storage section 7690. The other control units similarly include a microcomputer, a communication I/F, a storage section, and the like.

The driving system control unit 7100 controls the operation of devices related to the driving system of the vehicle in accordance with various kinds of programs. For example, the driving system control unit 7100 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like. The driving system control unit 7100 may have a function as a control device of an antilock brake system (ABS), electronic stability control (ESC), or the like.

The driving system control unit 7100 is connected with a vehicle state detecting section 7110. The vehicle state detecting section 7110, for example, includes at least one of a gyro sensor that detects the angular velocity of axial rotational movement of a vehicle body, an acceleration sensor that detects the acceleration of the vehicle, and sensors for detecting an amount of operation of an accelerator pedal, an amount of operation of a brake pedal, the steering angle of a steering wheel, an engine speed or the rotational speed of wheels, and the like. The driving system control unit 7100 performs arithmetic processing using a signal input from the vehicle state detecting section 7110, and controls the internal combustion engine, the driving motor, an electric power steering device, the brake device, and the like.

The body system control unit 7200 controls the operation of various kinds of devices provided to the vehicle body in accordance with various kinds of programs. For example, the body system control unit 7200 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 7200. The body system control unit 7200 receives these input radio waves or signals, and controls a door lock device, the power window device, the lamps, or the like of the vehicle.

The battery control unit 7300 controls a secondary battery 7310, which is a power supply source for the driving motor, in accordance with various kinds of programs. For example, the battery control unit 7300 is supplied with information about a battery temperature, a battery output voltage, a remaining capacitance in the battery, or the like from a battery device including the secondary battery 7310. The battery control unit 7300 performs arithmetic processing using these signals, and performs control for regulating the temperature of the secondary battery 7310 or controls a cooling device provided to the battery device or the like.

The outside-vehicle information detecting unit 7400 detects information about the outside of the vehicle including the vehicle control system 7000. For example, the outside-vehicle information detecting unit 7400 is connected with at least one of an imaging section 7410 and an outside-vehicle information detecting section 7420. The imaging section 7410 includes at least one of a time-of-flight (ToF) camera, a stereo camera, a monocular camera, an infrared camera, and other cameras. The outside-vehicle information detecting section 7420, for example, includes at least one of an environmental sensor for detecting current atmospheric conditions or weather conditions and a peripheral information detecting sensor for detecting another vehicle, an obstacle, a pedestrian, or the like on the periphery of the vehicle including the vehicle control system 7000.

The environmental sensor, for example, may be at least one of a rain drop sensor detecting rain, a fog sensor detecting a fog, a sunshine sensor detecting a degree of sunshine, and a snow sensor detecting a snowfall. The peripheral information detecting sensor may be at least one of an ultrasonic sensor, a radar device, and a LIDAR device (Light detection and Ranging device, or Laser imaging detection and ranging device). Each of the imaging section 7410 and the outside-vehicle information detecting section 7420 may be provided as an independent sensor or device, or may be provided as a device in which a plurality of sensors or devices are integrated.

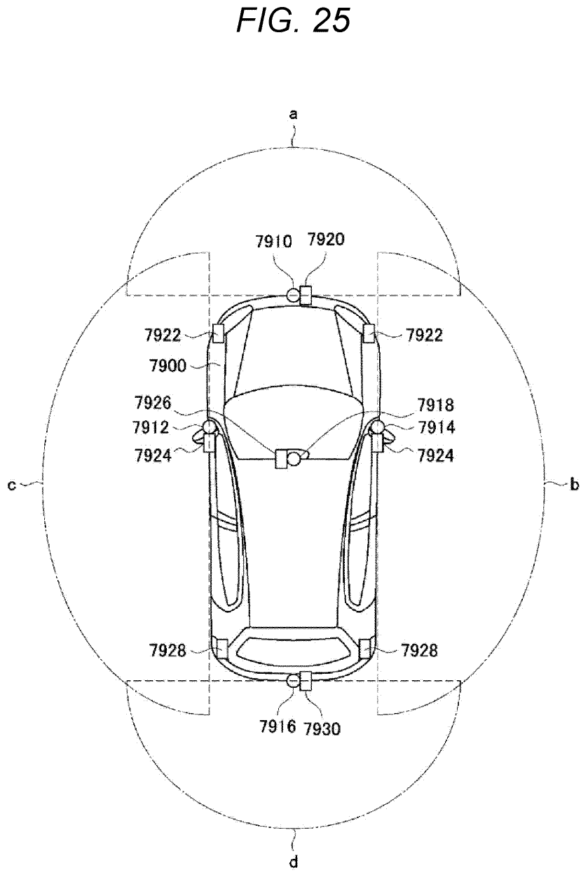

Here, FIG. 25 illustrates an example of installation positions of the imaging section 7410 and the outside-vehicle information detecting section 7420. Imaging sections 7910, 7912, 7914, 7916, and 7918 are, for example, disposed at at least one of positions on a front nose, sideview mirrors, a rear bumper, or a back door of the vehicle 7900 or a position on an upper portion of a windshield within the interior of the vehicle. The imaging section 7910 provided to the front nose and the imaging section 7918 provided to the upper portion of the windshield within the interior of the vehicle obtain mainly an image of the front of the vehicle 7900. The imaging sections 7912 and 7914 provided on the sideview mirrors acquire mainly an image of the sides of the vehicle 7900. The imaging section 7916 provided to the rear bumper or the back door obtains mainly an image of the rear of the vehicle 7900. The imaging section 7918 provided to the upper portion of the windshield within the interior of the vehicle is used mainly to detect a preceding vehicle, a pedestrian, an obstacle, a signal, a traffic sign, a lane, or the like.

Note that FIG. 25 illustrates an example of imaging ranges of the respective imaging sections 7910, 7912, 7914, and 7916. An imaging range a indicates the imaging range of the imaging section 7910 provided on the front nose, imaging ranges b and c indicate the imaging ranges of the imaging sections 7912 and 7914 provided on the sideview mirrors, respectively, and an imaging range d indicates the imaging range of the imaging section 7916 provided on the rear bumper or the back door. A bird's-eye image of the vehicle 7900 as viewed from above can be obtained by superimposing image data captured by the imaging sections 7910, 7912, 7914, and 7916, for example.

Outside-vehicle information detectors 7920, 7922, 7924, 7926, 7928, and 7930 provided on the front, rear, sides, and corners of the vehicle 7900 and the upper portion of the windshield within the interior of the vehicle may be, for example, an ultrasonic sensor or a radar device. The outside-vehicle information detectors 7920, 7926, and 7930 provided on the front nose, the rear bumper, and the back door of the vehicle 7900 and on the upper portion of the windshield within the interior of the vehicle may be, for example, a LIDAR device. These outside-vehicle information detecting sections 7920 to 7930 are used mainly to detect a preceding vehicle, a pedestrian, an obstacle, or the like.

Returning to FIG. 24, the description will be continued. The outside-vehicle information detecting unit 7400 makes the imaging section 7410 image an image of the outside of the vehicle, and receives imaged image data. In addition, the outside-vehicle information detecting unit 7400 receives detection information from the outside-vehicle information detecting section 7420 connected to the outside-vehicle information detecting unit 7400. In a case where the outside-vehicle information detecting section 7420 is an ultrasonic sensor, a radar device, or a LIDAR device, the outside-vehicle information detecting unit 7400 transmits an ultrasonic wave, an electromagnetic wave, or the like, and receives information of a received reflected wave. On the basis of the received information, the outside-vehicle information detecting unit 7400 may perform processing of detecting an object such as a human, a vehicle, an obstacle, a sign, a character on a road surface, or the like, or processing of detecting a distance thereto. The outside-vehicle information detecting unit 7400 may perform environment recognition processing of recognizing a rainfall, a fog, road surface conditions, or the like on the basis of the received information. The outside-vehicle information detecting unit 7400 may calculate a distance to an object outside the vehicle on the basis of the received information.

In addition, on the basis of the received image data, the outside-vehicle information detecting unit 7400 may perform image recognition processing of recognizing a human, a vehicle, an obstacle, a sign, a character on a road surface, or the like, or processing of detecting a distance thereto. The outside-vehicle information detecting unit 7400 may subject the received image data to processing such as distortion correction, alignment, or the like, and combine the image data imaged by a plurality of different imaging sections 7410 to generate a bird's-eye image or a panoramic image. The outside-vehicle information detecting unit 7400 may perform viewpoint conversion processing using the image data imaged by the imaging section 7410 including the different imaging parts.

The in-vehicle information detecting unit 7500 detects information about the inside of the vehicle. The in-vehicle information detecting unit 7500 is, for example, connected with a driver state detecting section 7510 that detects the state of a driver. The driver state detecting section 7510 may include a camera that images the driver, a biosensor that detects biological information of the driver, a microphone that collects sound within the interior of the vehicle, or the like. The biosensor is, for example, disposed in a seat surface, the steering wheel, or the like, and detects biological information of an occupant sitting in a seat or the driver holding the steering wheel. On the basis of detection information input from the driver state detecting section 7510, the in-vehicle information detecting unit 7500 may calculate a degree of fatigue of the driver or a degree of concentration of the driver, or may determine whether the driver is dozing. The in-vehicle information detecting unit 7500 may subject an audio signal obtained by the collection of the sound to processing such as noise canceling processing or the like.

The integrated control unit 7600 controls general operation within the vehicle control system 7000 in accordance with various kinds of programs. The integrated control unit 7600 is connected with an input section 7800. The input section 7800 is implemented by a device capable of input operation by an occupant, such, for example, as a touch panel, a button, a microphone, a switch, a lever, or the like. The integrated control unit 7600 may be supplied with data obtained by voice recognition of voice input through the microphone. The input section 7800 may, for example, be a remote control device using infrared rays or other radio waves, or an external connecting device such as a mobile telephone, a personal digital assistant (PDA), or the like that supports operation of the vehicle control system 7000. The input section 7800 may be, for example, a camera. In that case, an occupant can input information by gesture. Alternatively, data may be input which is obtained by detecting the movement of a wearable device that an occupant wears. Further, the input section 7800 may, for example, include an input control circuit or the like that generates an input signal on the basis of information input by an occupant or the like using the above-described input section 7800, and which outputs the generated input signal to the integrated control unit 7600. An occupant or the like inputs various kinds of data or gives an instruction for processing operation to the vehicle control system 7000 by operating the input section 7800.

The storage section 7690 may include a read only memory (ROM) that stores various kinds of programs executed by the microcomputer and a random access memory (RAM) that stores various kinds of parameters, operation results, sensor values, or the like. In addition, the storage section 7690 may be implemented by a magnetic storage device such as a hard disc drive (HDD) or the like, a semiconductor storage device, an optical storage device, a magneto-optical storage device, or the like.

The general-purpose communication I/F 7620 is a communication I/F used widely, which communication I/F mediates communication with various apparatuses present in an external environment 7750. The general-purpose communication I/F 7620 may implement a cellular communication protocol such as global system for mobile communications (GSM (registered trademark)), worldwide interoperability for microwave access (WiMAX (registered trademark)), long term evolution (LTE (registered trademark)), LTE-advanced (LTE-A), or the like, or another wireless communication protocol such as wireless LAN (referred to also as wireless fidelity (Wi-Fi (registered trademark)), Bluetooth (registered trademark), or the like. The general-purpose communication I/F 7620 may, for example, connect to an apparatus (for example, an application server or a control server) present on an external network (for example, the Internet, a cloud network, or a company-specific network) via a base station or an access point. In addition, the general-purpose communication I/F 7620 may connect to a terminal present in the vicinity of the vehicle (which terminal is, for example, a terminal of the driver, a pedestrian, or a store, or a machine type communication (MTC) terminal) using a peer to peer (P2P) technology, for example.

The dedicated communication I/F 7630 is a communication I/F that supports a communication protocol developed for use in vehicles. The dedicated communication I/F 7630 may implement a standard protocol such, for example, as wireless access in vehicle environment (WAVE), which is a combination of institute of electrical and electronic engineers (IEEE) 802.11p as a lower layer and IEEE 1609 as a higher layer, dedicated short range communications (DSRC), or a cellular communication protocol. The dedicated communication I/F 7630 typically carries out V2X communication as a concept including one or more of communication between a vehicle and a vehicle (Vehicle to Vehicle), communication between a road and a vehicle (Vehicle to Infrastructure), communication between a vehicle and a home (Vehicle to Home), and communication between a pedestrian and a vehicle (Vehicle to Pedestrian).

The positioning section 7640, for example, performs positioning by receiving a global navigation satellite system (GNSS) signal from a GNSS satellite (for example, a GPS signal from a global positioning system (GPS) satellite), and generates positional information including the latitude, longitude, and altitude of the vehicle. Incidentally, the positioning section 7640 may identify a current position by exchanging signals with a wireless access point, or may obtain the positional information from a terminal such as a mobile telephone, a personal handyphone system (PHS), or a smart phone that has a positioning function.

The beacon receiving section 7650, for example, receives a radio wave or an electromagnetic wave transmitted from a radio station installed on a road or the like, and thereby obtains information about the current position, congestion, a closed road, a necessary time, or the like. Incidentally, the function of the beacon receiving section 7650 may be included in the dedicated communication I/F 7630 described above.

The in-vehicle device I/F 7660 is a communication interface that mediates connection between the microcomputer 7610 and various in-vehicle devices 7760 present within the vehicle. The in-vehicle device I/F 7660 may establish wireless connection using a wireless communication protocol such as wireless LAN, Bluetooth (registered trademark), near field communication (NFC), or wireless universal serial bus (WUSB). In addition, the in-vehicle device I/F 7660 may establish wired connection by universal serial bus (USB), high-definition multimedia interface (HDMI (registered trademark)), mobile high-definition link (MHL), or the like via a connection terminal (and a cable if necessary) not depicted in the figures. The in-vehicle devices 7760 may, for example, include at least one of a mobile device and a wearable device possessed by an occupant and an information device carried into or attached to the vehicle. The in-vehicle devices 7760 may also include a navigation device that searches for a path to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals or the like in conformity with a predetermined protocol supported by the communication network 7010.

The microcomputer 7610 of the integrated control unit 7600 controls the vehicle control system 7000 in accordance with various kinds of programs on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. For example, the microcomputer 7610 may calculate a control target value for the driving force generating device, the steering mechanism, or the braking device on the basis of the obtained information about the inside and outside of the vehicle, and output a control command to the driving system control unit 7100. For example, the microcomputer 7610 may perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like. In addition, the microcomputer 7610 may perform cooperative control intended for automated driving, which makes the vehicle to travel automatedly without depending on the operation of the driver, or the like, by controlling the driving force generating device, the steering mechanism, the braking device, or the like on the basis of the obtained information about the surroundings of the vehicle.

The microcomputer 7610 may generate three-dimensional distance information between the vehicle and an object such as a surrounding structure, a person, or the like, and generate local map information including information about the surroundings of the current position of the vehicle, on the basis of information obtained via at least one of the general-purpose communication I/F 7620, the dedicated communication I/F 7630, the positioning section 7640, the beacon receiving section 7650, the in-vehicle device I/F 7660, and the vehicle-mounted network I/F 7680. In addition, the microcomputer 7610 may predict danger such as collision of the vehicle, approaching of a pedestrian or the like, an entry to a closed road, or the like on the basis of the obtained information, and generate a warning signal. The warning signal may, for example, be a signal for producing a warning sound or lighting a warning lamp.

The sound/image output section 7670 transmits an output signal of at least one of a sound and an image to an output device capable of visually or auditorily notifying information to an occupant of the vehicle or the outside of the vehicle. In the example of FIG. 24, an audio speaker 7710, a display section 7720, and an instrument panel 7730 are illustrated as the output device. The display section 7720 may, for example, include at least one of an on-board display and a head-up display. The display section 7720 may have an augmented reality (AR) display function. The output device may be other than these devices, and may be another device such as headphones, a wearable device such as an eyeglass type display worn by an occupant or the like, a projector, a lamp, or the like. In a case where the output device is a display device, the display device visually displays results obtained by various kinds of processing performed by the microcomputer 7610 or information received from another control unit in various forms such as text, an image, a table, a graph, or the like. In addition, in a case where the output device is an audio output device, the audio output device converts an audio signal constituted of reproduced audio data or sound data or the like into an analog signal, and auditorily outputs the analog signal.

Note that at least two control units connected to each other via the communication network 7010 in the example illustrated in FIG. 24 may be integrated into one control unit. Alternatively, each individual control unit may include a plurality of control units. Further, the vehicle control system 7000 may include another control unit not depicted in the figures. In addition, part or the whole of the functions performed by one of the control units in the above description may be assigned to another control unit. That is, predetermined arithmetic processing may be performed by any of the control units as long as information is transmitted and received via the communication network 7010. Similarly, a sensor or a device connected to one of the control units may be connected to another control unit, and a plurality of control units may mutually transmit and receive detection information via the communication network 7010.

Note that a computer program for realizing each function of the imaging device 100 according to the present embodiment described with reference to FIG. 2 can be mounted on any control unit or the like. Furthermore, a computer-readable recording medium in which such a computer program is stored can be provided. The recording medium is, for example, a magnetic disk, an optical disc, a magneto-optical disk, a flash memory, or the like. Furthermore, the computer program described above may be distributed via, for example, a network without using the recording medium.

In the vehicle control system 7000 described above, the imaging device 100 according to the present embodiment described with reference to FIG. 2 may be applied to the imaging 74100 of the application example illustrated in FIG. 24.

Note that the present technology can have the following configurations.

(1)

A photodetection element including:
a pixel array section that disposes a first pixel and a second pixel different from the first pixel along the same light receiving surface;
a conversion section that performs analog-digital conversion of an output signal output from the first pixel via a signal line into a digital signal;
a signal holding section that is capable of holding an output signal of the second pixel and suppresses fluctuation of the output signal according to a period of the analog-digital conversion; and
a first circuit that outputs a detection signal indicating occurrence of an event in a case where the output signal of the second pixel exceeds a predetermined threshold.
   (2)

The photodetection element according to (1), in which
the second pixel includes:
a photoelectric conversion element that outputs a signal according to an amount of received light; and
a voltage conversion section that converts the signal into a voltage signal, and
the signal holding section holds the voltage signal of the voltage conversion section and suppresses fluctuation of the voltage signal.
   (3)

The photodetection element according to (2), in which
the pixel array section includes:
a plurality of the first pixels arranged two-dimensionally along the light receiving surface; and
a plurality of the second pixels arranged two-dimensionally along the light receiving surface,
the photodetection element further includes a plurality of the signal holding sections respectively corresponding to the plurality of second pixels,
during a period in which the analog-digital conversion of the output signal via the signal line is performed, the signal holding sections of the second pixels in a predetermined range from the signal line suppress fluctuation of the corresponding output signal.
   (4)

The photodetection element according to (3), further including
a control section that controls a supply potential of the voltage conversion section,
in which the control section is capable of suppressing driving of the voltage conversion section of each of the second pixels in a predetermined range from the signal line in a period in which the analog-digital conversion of the output signal via the signal line is performed.
   (5)

The photodetection element according to (1), in which
the signal holding section includes:
a capacitance that holds an output signal of the second pixel; and
a first switching element that brings a signal line connecting the capacitance and the second pixel into a conductive state or a non-conductive state.
   (6)

The photodetection element according to (5), in which
the signal holding section further includes
a buffer capable of outputting a potential according to a charge of the capacitance to the first circuit.
   (7)

The photodetection element according to (6), in which
the signal holding section further includes
a second switching element that brings a signal line connecting the second pixel and the first circuit into a conductive state or a non-conductive state.
   (8)

The photodetection element according to (6), in which
the first switching element includes one end connected to a signal line connecting the second pixel and the first circuit and another end connected to an input terminal of the buffer, and
further includes
a second switching element including one end connected to an output terminal of the buffer and another end connected to the second pixel.
   (9)

The photodetection element according to (6), in which
the first switching element includes one end connected to the second pixel and the other end connected to the first circuit,
an input terminal of the buffer is connected to the first circuit, and
the photodetection element further includes a second switching element including one end connected to an output terminal of the buffer and the other end connected to the second pixel.
   (10)

The photodetection element according to (5), in which
the signal holding section further includes:
an operational amplifier, a 12th switching element, a 21st switching element, and a 22nd switching element,
the first switching element includes one end connected to a signal line connecting the second pixel and the first circuit and the other end connected to one end of the capacitance,
the other end of the capacitance is connected to an inverting input terminal of the operational amplifier,
a non-inverting input terminal of the operational amplifier is connected to a predetermined low potential,
the 21st switching element includes one end connected to an output terminal of the operational amplifier and the other end connected to the second pixel,
the 12th switching element includes one end connected to the output terminal of the operational amplifier and the other end connected to the other end of the capacitance, and
the 22nd switching element includes one end connected to the output terminal of the operational amplifier and the other end connected to the one end of the capacitance.
   (11)

The photodetection element according to (5), in which
the signal holding section further includes:
an operational amplifier, a 12th switching element, a 21st switching element, and a 22nd switching element,
the first switching element includes one end connected to the second pixel and the other end connected to the first circuit,
one end of the capacitance is connected to the first circuit and the other end of the capacitance is connected to an inverting input terminal of the operational amplifier,
a non-inverting input terminal of the operational amplifier is connected to a predetermined low potential,
the 21st switching element includes one end connected to an output terminal of the operational amplifier and the other end connected to the second pixel,
the 12th switching element includes one end connected to the output terminal of the operational amplifier and the other end connected to the other end of the capacitance, and
the 22nd switching element includes one end connected to the output terminal of the operational amplifier and the other end connected to the one end of the capacitance.
   (12)

The photodetection element according to (7), in which the first switching element is brought into a non-conductive state and the second switching element is brought into a conductive state according to a period of the analog-digital conversion.

(13)

The photodetection element according to (7), in which the first switching element is brought into a conductive state and the second switching element is brought into a non-conductive state during a sampling period in which charges are accumulated in the capacitance.

(14)

The photodetection element according to (8), in which the first switching element is brought into a non-conductive state and the second switching element is brought into a conductive state according to a period of the analog-digital conversion.

(15)

The photodetection element according to (9), in which the first switching element is brought into a non-conductive state and the second switching element is brought into a conductive state according to a period of the analog-digital conversion.

(16)

The photodetection element according to (10), in which the first switching element and the 12th switching element are brought into a non-conductive state, and the 21st switching element and the 22nd switching element are brought into a conductive state according to a period of the analog-digital conversion.

(17)

The photodetection element according to (10), in which the first switching element and the 12th switching element are brought into a conductive state, and the 21st switching element and the 22nd switching element are brought into a non-conductive state during a sampling period in which charges are accumulated in the capacitance.

(18)

The photodetection element according to (11), in which the first switching element and the 12th switching element are brought into a non-conductive state, and the 21st switching element and the 22nd switching element are brought into a conductive state according to a period of the analog-digital conversion.

(19)

The photodetection element according to (1), in which the pixel array section is configured in a first element, and the conversion section, the signal holding section, and the first circuit are configured in a second element different from the first element.

(20)

Electronic equipment including:
the photodetection element according to (1); and
an optical system that focuses light on the light receiving surface.

Aspects of the present disclosure are not limited to the above-described individual embodiments, but include various modifications that can be conceived by those skilled in the art, and the effects of the present disclosure are not limited to the above-described contents. That is, various additions, modifications, and partial deletions are possible without departing from the conceptual idea and spirit of the present disclosure derived from the matters defined in the claims and equivalents thereof.

### REFERENCE SIGNS LIST

10 Pixel array section
30a EVS pixel
30b Gradation pixel
110 Imaging lens
200 Photodetection element
201 First layer element
201, 202 Second layer element
212 AD converter
221 Photoelectric conversion element
222 Logarithmic conversion section
331, 3310a to 3310e Pixel voltage holding section
331a, 354a Capacitance
331a, 352 Buffer
352a Operational amplifier
VSL Vertical signal line
Φ1 First switching element
Φ2 First switching element
Φ11 11th switching element
Φ12 12th switching element
Φ21 21st switching element
Φ22 22nd switching element

1. A photodetection element comprising:
a pixel array section that disposes a first pixel and a second pixel different from the first pixel along a same light receiving surface;
a conversion section that performs analog-digital conversion of an output signal output from the first pixel via a signal line into a digital signal;
a signal holding section that is capable of holding an output signal of the second pixel and suppresses fluctuation of the output signal according to a period of the analog-digital conversion; and
a first circuit that outputs a detection signal indicating occurrence of an event in a case where the output signal of the second pixel exceeds a predetermined threshold.

2. The photodetection element according to claim 1, wherein
the second pixel includes:
a photoelectric conversion element that outputs a signal according to an amount of received light; and
a voltage conversion section that converts the signal into a voltage signal, and
the signal holding section holds the voltage signal of the voltage conversion section and suppresses fluctuation of the voltage signal.

3. The photodetection element according to claim 2, wherein
the pixel array section includes:
a plurality of the first pixels arranged two-dimensionally along the light receiving surface; and
a plurality of the second pixels arranged two-dimensionally along the light receiving surface,
the photodetection element further comprises a plurality of the signal holding sections respectively corresponding to the plurality of second pixels,
during a period in which the analog-digital conversion of the output signal via the signal line is performed, the signal holding sections of the second pixels in a predetermined range from the signal line suppress fluctuation of the corresponding output signal.

4. The photodetection element according to claim 3, further comprising
a control section that controls a supply potential to the voltage conversion section,
wherein the control section is capable of suppressing driving of the voltage conversion section of each of the second pixels in a predetermined range from the signal line in a period in which the analog-digital conversion of the output signal via the signal line is performed.

5. The photodetection element according to claim 1, wherein
the signal holding section includes:
a capacitance that holds an output signal of the second pixel; and
a first switching element that brings a signal line connecting the capacitance and the second pixel into a conductive state or a non-conductive state.

6. The photodetection element according to claim 5, wherein
the signal holding section further includes
a buffer capable of outputting a potential according to a charge of the capacitance to the first circuit.

7. The photodetection element according to claim 6, wherein
the signal holding section further includes
a second switching element that brings a signal line connecting the second pixel and the first circuit into a conductive state or a non-conductive state.

8. The photodetection element according to claim 6, wherein
the first switching element includes one end connected to a signal line connecting the second pixel and the first circuit and another end connected to an input terminal of the buffer, and
further includes
a second switching element including one end connected to an output terminal of the buffer and another end connected to the second pixel.

9. The photodetection element according to claim 6, wherein
the first switching element includes one end connected to the second pixel and another end connected to the first circuit,
an input terminal of the buffer is connected to the first circuit, and
the photodetection element further includes a second switching element including one end connected to an output terminal of the buffer and another end connected to the second pixel.

10. The photodetection element according to claim 5, wherein
the signal holding section further includes:
an operational amplifier, a 12th switching element, a 21st switching element, and a 22nd switching element,
the first switching element includes one end connected to a signal line connecting the second pixel and the first circuit and another end connected to one end of the capacitance,
another end of the capacitance is connected to an inverting input terminal of the operational amplifier,
a non-inverting input terminal of the operational amplifier is connected to a predetermined low potential,
the 21st switching element includes one end connected to an output terminal of the operational amplifier and another end connected to the second pixel,
the 12th switching element includes one end connected to the output terminal of the operational amplifier and another end connected to the another end of the capacitance, and
the 22nd switching element includes one end connected to the output terminal of the operational amplifier and another end connected to the one end of the capacitance.

11. The photodetection element according to claim 5, wherein
the signal holding section further includes:
an operational amplifier, a 12th switching element, a 21st switching element, and a 22nd switching element,
the first switching element includes one end connected to the second pixel and another end connected to the first circuit,
one end of the capacitance is connected to the first circuit and another end of the capacitance is connected to an inverting input terminal of the operational amplifier,
a non-inverting input terminal of the operational amplifier is connected to a predetermined low potential,
the 21st switching element includes one end connected to an output terminal of the operational amplifier and another end connected to the second pixel,
the 12th switching element includes one end connected to the output terminal of the operational amplifier and another end connected to the another end of the capacitance, and
the 22nd switching element includes one end connected to the output terminal of the operational amplifier and another end connected to the one end of the capacitance.

12. The photodetection element according to claim 7, wherein the first switching element is brought into a non-conductive state and the second switching element is brought into a conductive state according to a period of the analog-digital conversion.

13. The photodetection element according to claim 7, wherein the first switching element is brought into a conductive state and the second switching element is brought into a non-conductive state during a sampling period in which charges are accumulated in the capacitance.

14. The photodetection element according to claim 8, wherein the first switching element is brought into a non-conductive state and the second switching element is brought into a conductive state according to a period of the analog-digital conversion.

15. The photodetection element according to claim 9, wherein the first switching element is brought into a non-conductive state and the second switching element is brought into a conductive state according to a period of the analog-digital conversion.

16. The photodetection element according to claim 10, wherein the first switching element and the 12th switching element are brought into a non-conductive state, and the 21st switching element and the 22nd switching element are brought into a conductive state according to a period of the analog-digital conversion.

17. The photodetection element according to claim 10, wherein the first switching element and the 12th switching element are brought into a conductive state, and the 21st switching element and the 22nd switching element are brought into a non-conductive state during a sampling period in which charges are accumulated in the capacitance.

18. The photodetection element according to claim 11, wherein the first switching element and the 12th switching element are brought into a non-conductive state, and the 21st switching element and the 22nd switching element are brought into a conductive state according to a period of the analog-digital conversion.

19. The photodetection element according to claim 1, wherein
the pixel array section is configured in a first element, and
the conversion section, the signal holding section, and the first circuit are configured in a second element different from the first element.

20. Electronic equipment comprising:
the photodetection element according to claim 1; and
an optical system that focuses light on the light receiving surface.
